(19) United States
(12) Patent Application Publication
(10) Pub. No.: US 2026/0112084 A1
(43) Pub. Date: Apr. 23, 2026

(54) IDENTIFYING AND REMOVING CHARACTER OVERLAPS FOR OPTICAL CHARACTER RECOGNITION PROCESSING

(71) Applicant: Capital One Financial Corporation, McLean, VA (US)

(72) Inventors: Keith Smith, Raleigh, NC (US); Evan Kountouris, Raleigh, NC (US)

(21) Appl. No.: 18/920,767

(22) Filed: Oct. 18, 2024

(51) Int. Cl. G06T 11/60

(52) U.S. Cl. CPC G06T 11/60

(57) ABSTRACT

Techniques for identifying and eliminating overlaps of characters in an image that are to be processed for character recognition involve selecting a line of contours within the image, generating a line boundary around the line, identifying respective starting edgepoints on each edge of a contour that intersects the line boundary, and tracing a section of the contour by following each edge of the contour until a stopping point indicating an end to the tracing of the section of the contour is reached. The stopping point may comprise a determination that either (i) an end of the section of the contour is reached, or (ii) the section of the contour comprises a first sub-contour, and an intersection between the first sub-contour and a second sub-contour is reached. Based on the determination, the tracing of the section of the contour is completed, and the traced section is deleted from the image.

### BACKGROUND

In today's digital age, many tasks that were traditionally performed manually are performed electronically, including capturing images of physical data and extracting information from images of scanned data. Optical character recognition (OCR)—the process of converting images of handwritten, printed, or typed text into machine-encoded text—has become a prevalent means of extracting information in today's digital world. Widespread usage of OCR has prompted developments in OCR technology. OCR is used across industries and in many aspects of daily life, including, as some examples, business practices, banking procedures, academia, and even personal tasks. Modern consumers expect to be able to perform such tasks involving OCR in an accessible and convenient way, such as via a smartphone device. Given the quick rise in consumer demands, there is a need for improved technology related to processing image data for character recognition.

### OVERVIEW

Disclosed herein is new software technology for processing image data for character recognition that involves identifying overlaps between typed characters and other markings in an image of a physical artifact (e.g., a document, a bank check, etc.), and then eliminating those overlaps in order to prepare the typed characters for character recognition, thereby increasing the accuracy of the character recognition.

In one aspect, the disclosed software technology may take the form of a method to be carried out by a computing platform that involves (i) identifying, in an image, a line of contours that are to be processed for textual character recognition, (ii) generating a line boundary around the line of contours, (iii) identifying a first edgepoint of a first edge of a contour that intersects the line boundary, (iv) identifying a second edgepoint of a second edge of the contour, (v) based on the first and second edgepoints, following each edge of the contour and thereby begin tracing a section of the contour, (vi), while tracing the section of the contour, making a determination that the section of the contour comprises a first sub-contour of the contour and that an intersection between the first sub-contour and a second sub-contour of the contour is reached, (vii) based on the determination, completing tracing the section of the contour comprising the first sub-contour, and (viii) causing the first sub-contour to be deleted from the image.

In an example, generating the line boundary around the line of contours may involve (i) sorting contours in the image by size into at least medium contours and large contours, wherein the line of contours comprises a plurality of medium contours and at least one large contour, and (ii) generating the line boundary by adding a padding distance around a bounding box that surrounds the medium contours in the line of contours.

In an example, the padding distance may comprise a distance of five pixels.

In an example, following each edge of the first contour and thereby begin tracing the section of the first contour may involve (i) for the first edge of the first contour, iteratively adding a next adjacent edgepoint to the first edge, starting from the first edgepoint, and (ii) for the second edge of the first contour, iteratively adding a next adjacent edgepoint to the second edge, starting from the second edgepoint.

In one embodiment, following each edge of the first contour may further involve (1) comparing (i) a first distance between a next potential edgepoint on a given edge of the first contour and a nearest edgepoint on the other edge of the contour and (ii) a second distance between a current edgepoint on the given edge of the first contour and a nearest edgepoint on the other edge of the contour, and (i) based on the comparison, (i) if the first distance is greater than the second distance, adding a next edgepoint on the other edge, or (ii) if the first distance is less than the second distance, adding a next edgepoint on the given edge.

In another embodiment, following each edge of the first contour may further involve, for each edgepoint that is iteratively added to an edge, determining (i) a respective edgepoint angle and (ii) a respective edgepoint width, wherein the determination that the intersection between the first sub-contour and the second sub-contour is reached comprises a determination that either (i) a difference between the respective edgepoint angle of a current edgepoint on the first edge and the respective edgepoint angle of a current edgepoint on the second edge is greater than a maximum angle threshold or (ii) a respective edgepoint width of the current edgepoint on either the first edge or the second edge is greater than a maximum width threshold. In one implementation of such an embodiment, a respective edgepoint angle may comprise an angle of a line of best fit between a given edgepoint on a given edge and one or more preceding edgepoints on the given edge, and a respective edgepoint width may comprise a distance between a given edgepoint on a given edge of the contour and a nearest edgepoint on the other edge of the contour. In one example of such an implementation, the maximum angle threshold may be fifteen degrees, and the maximum width threshold may be derived based on an average of respective edgepoint widths for all edgepoints on the section of the contour.

In an example, the method may further involve, after making the determination that the intersection between the first sub-contour and the second sub-contour is reached, determining whether a third sub-contour that is a continuation of the first sub-contour extends beyond the intersection by (i) determining a direction of travel for traversing the intersection, (ii) iteratively traversing the intersection in the direction of travel, and (iii) for each iteration of traversing the intersection, determining whether any points outside the contour are found within a given distance perpendicular to the direction of travel.

In one implementation, determining the direction of travel for traversing the intersection may involve (i) identifying the last edgepoint on a given edge that has an edgepoint angle that differs from a corresponding last edgepoint on the other edge by less than the maximum angle threshold and a respective edgepoint width less than the maximum width threshold, (ii) calculating an average of the respective edgepoint angles of the last edgepoints, and (iii) determining the direction of travel based on the average of the respective edgepoint angles.

Further, iteratively traversing the intersection in the direction of travel may involve (i) identifying a middle point between the first and second last edgepoints, and (ii) based on the middle point, iteratively traversing the intersection in the direction of travel, wherein each iteration comprises an iteration distance that is derived based on a distance between the last edgepoint on the given edge and a current edgepoint on the given edge.

Further yet, determining whether any points outside the contour are found within a given distance perpendicular to the direction of travel may involve (i) determining a maximum width of the first sub-contour, wherein the given distance comprises the maximum width, and (ii) for each iteration, determining (a) if a point outside the contour is found in a first lateral direction perpendicular to the direction of travel and (b) if a point outside the contour is found in a second lateral direction perpendicular to the direction of travel.

In an example, the contour may be a first contour, and the method may further involve, (i) identifying a first edgepoint of a first edge of a second contour that intersects the line boundary, (ii) identifying a second edgepoint of a second edge of the second contour, (iii) based on the first and second edgepoints, following each edge of the second contour and thereby begin tracing a section of the second contour, (iv) while tracing the section of the second contour, making a determination that an end of the second contour is reached, (v) based on the determination, completing tracing the section of the second contour, and (vi) causing the second contour to be deleted from the image. In one embodiment, tracing the section of the second contour may involve (i) for the first edge of the second contour, iteratively adding a next adjacent edgepoint to the first edge, starting from the first edgepoint, and (ii) for the second edge of the second contour, iteratively adding a next adjacent edgepoint to the second edge, starting from the second edgepoint, wherein the determination that the end of the second contour is reached comprises a determination that a next potential edgepoint on a given edge would overlap an existing edgepoint on the other edge.

In an example, causing the section of the contour to be deleted from the image may involve updating a respective color of each pixel in the section of the contour to match a background color of the image.

In an example, each contour may comprise a respective set of contiguous pixels identified in image data corresponding to the image.

In an example, the line of contours may comprise a set of contours having a substantially similar y-axis value or x-axis value within the image.

In another aspect, disclosed herein is a computing platform that includes a communication interface, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing methods.

In yet another aspect, disclosed herein is a non-transitory computer-readable medium provisioned with program instructions that, when executed by at least one processor, cause a computing platform to carry out the functions disclosed herein, including but not limited to the functions of the foregoing methods.

One of ordinary skill in the art will appreciate these as well as numerous other aspects in reading the following disclosure.

### BRIEF DESCRIPTION OF THE DRAWINGS

FIG. 1 depicts an example bank check including a MICR line and a consumer signature that overlaps the MICR line.

FIG. 2 depicts an example scanned image of a bank check including a curved MICR line and a consumer signature that overlaps the curved MICR line.

FIG. 3 depicts an example computing environment in which the disclosed functionality may be implemented.

FIG. 4 depicts a flow diagram of example functionality for identifying contours for deletion according to one embodiment of the disclosed software technology.

FIGS. 5A, 5B, and 5C depict example contours that may be processed for line allocation according to aspects of the disclosed software technology.

FIGS. 6A and 6B depict an example line of contours that may be processed for contour deletion in accordance with aspects of the disclosed software technology.

FIG. 7 depicts a close-up view of the line of contours shown in FIG. 6B that may be processed for contour deletion in accordance with aspects of the disclosed software technology.

FIGS. 8A, 8B, 8C, and 8D illustrate examples of tracing a contour by iteratively adding edgepoints to edges of the contour in accordance with aspects of one embodiment of the disclosed software technology.

FIGS. 9A, 9B, and 9C illustrate examples for identifying an end of a contour and deleting the contour in accordance with aspects of one embodiment of the disclosed software technology.

FIGS. 10A and 10B illustrate examples for identifying an intersection between sub-contours and processing one or more of the sub-contours for deletion in accordance with aspects of one embodiment of the disclosed software technology.

FIG. 11 illustrates an example for traversing an intersection between sub-contours in accordance with aspects of one embodiment of the disclosed software technology.

FIGS. 12A, 12B, 12C, and 12D illustrate examples of identifying and processing contours for deletion in accordance with aspects of another embodiment of the disclosed software technology.

FIG. 13 depicts a structural diagram of an example back-end computing platform that may be configured to carry out back-end computing platform functionality according to the disclosed software technology.

FIG. 14 depicts a structural diagram of an example end-user device that may be configured to carry out end-user device functionality according to the disclosed software technology.

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### DETAILED DESCRIPTION

As mentioned above, OCR is used in many situations. However, some shortcomings in existing OCR technology remain that make certain character recognition scenarios challenging. For instance, existing OCR technology has trouble differentiating overlaps between handwritten and printed text. Shortcomings such as this can lead to inaccurate character recognition, which can be problematic for a variety of reasons.

One example area where shortcomings in existing OCR technology can be particularly problematic is online banking. The advent of online banking in recent years has led to an increase in electronic deposits of physical bank checks via banking applications (e.g., using a smartphone camera). In general, OCR is used to extract banking and routing information from physical bank checks in order to facilitate the transfer of funds from financial accounts. In this respect, a bank check typically includes a “MICR” line (i.e., “magnetic ink character recognition” line) comprising characters that collectively indicate a bank routing number, a check number, and a customer account number. In accordance with banking industry standards, MICR lines are printed on bank checks traditionally using magnetic ink (or toner) that enable a computing device (e.g. a check reading device) to scan the physical bank check and not only read the characters in the MICR line but also differentiate the MICR characters from any other markings made with non-magnetic ink, such as handwritten or stamped markings, that may overlap the MICR characters.

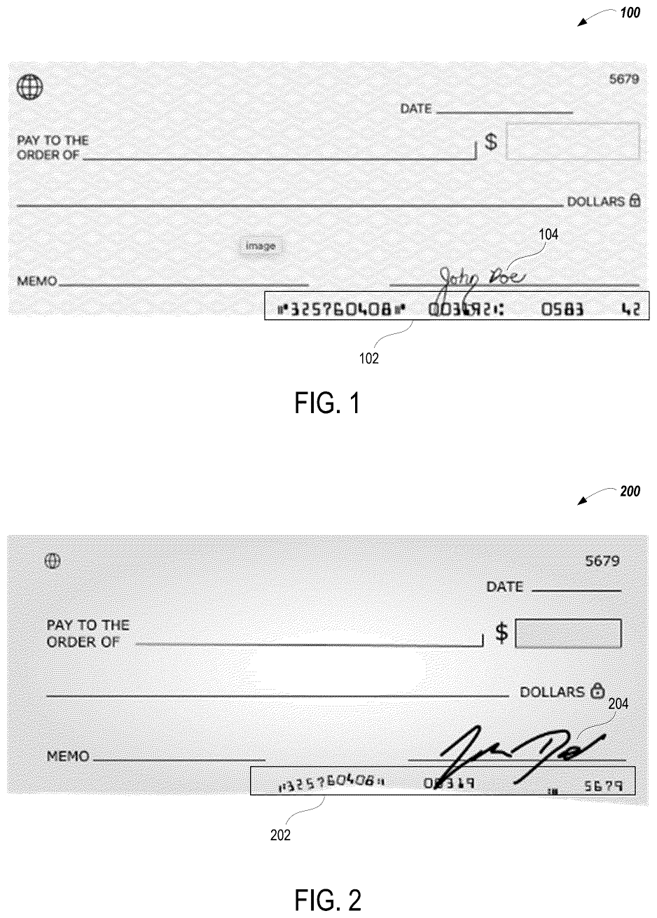

Turning now to FIG. 1, an example bank check 100 including an example MICR line 102 is depicted. The MICR line 102 may be printed using magnetic ink and may indicate information including a routing number and an account number for facilitating the transfer of funds from a financial institution and account associated with the routing and account numbers indicated on the check. In some situations, such as in the example of FIG. 1, one or more parts of a handwritten signature 104 may overlap one or more sections of the MICR line 102. In accordance with the discussion above, a check reading device that functions to scan the physical check 100 and read the MICR line 102 using OCR technology may be able to differentiate characters of the MICR line 102 from the signature 104 in any overlaps between the MICR line 102 and the signature 104 based on the magnetic ink of the MICR line 102, thereby enabling the characters of the MICR line 102 to be accurately recognized despite the overlaps.

However, the benefit of magnetic ink has been reduced with the advent of online banking, where bank checks are often deposited using a smartphone camera that captures an image of the check, which is then processed and deposited via a mobile banking application (e.g., in coordination with one or more back-end computing platforms). This practice may generally be referred to herein as a “mobile deposit.” In situations involving a mobile deposit, a scanned image of the bank check, rather than the physical bank check itself, is used to interpret the characters of the MICR line. In this regard, scanned images of bank checks can include markings that overlap characters in the image (e.g., a handwritten signature overlapping one or more characters of a MICR line) but do not benefit from the magnetic ink on the physical bank check, thus making it difficult for existing OCR technology to differentiate between the markings and the characters for the purposes of character recognition.

Consider the example shown in FIG. 2, which depicts a scanned image 200 of a bank check. In practice, the scanned image 200 may have been captured by a consumer via a software banking application using a camera of a computing device such as a smartphone or tablet during the process of completing a mobile deposit of the bank check. As shown in FIG. 2, the scanned image 200 includes a consumer signature 204 that overlaps a MICR line 202 in various places, thus obscuring one or more characters of the MICR line 202. Because mobile deposits do not utilize magnetic ink readers, it is difficult to differentiate between the signature 204 and the MICR line 202 in order to accurately recognize the characters in the MICR line 202 using existing OCR technology. Inaccurate recognition of characters in the MICR line can lead to undesirable outcomes, such as delayed deposit of funds or funds being withdrawn from an incorrect account, among other possibilities.

To address these and other problems with existing OCR technology, disclosed herein is new software technology related to processing image data for character recognition that involves new techniques for identifying and eliminating overlaps between characters in an image of a physical artifact (e.g., a document, a bank check, etc.) and other markings present in the image (e.g., handwritten markings such as a signature, written text, etc.). In the examples below, the disclosed software technology will be described in the context of evaluating scanned images of bank checks, but it should be understood that the disclosed software technology can be utilized to recognize characters in any situation that involves overlaps between printed text and other markings. Some nonlimiting examples of such situations may include text that has been stamped (e.g., stamped ink on printed ink) or text that has been annotated (e.g., handwritten annotations on printed text), among other possibilities.

At a high level, the disclosed functionality may involve (i) selecting, in an image, a line of contours that is to be processed for character recognition, (ii) generating a line boundary around the line of contours, (iii) identifying any contours that intersect the line boundary, (iv) for each respective contour that intersects the line boundary, determining a first edge and a second edge of the respective contour, (v) following the first and second edges of the respective contour to trace a section of the respective contour that is to be deleted, (vi) and deleting the traced section of the respective contour from the image. This functionality will be described in more detail further below. As discussed herein, a “contour” may refer to a set of contiguous pixels) in a scanned image, and a “line” may refer to a group of contours having a similar axis value along a given axis (e.g., a similar x-axis for vertical script or a similar y-axis for horizontal script) in the scanned image.

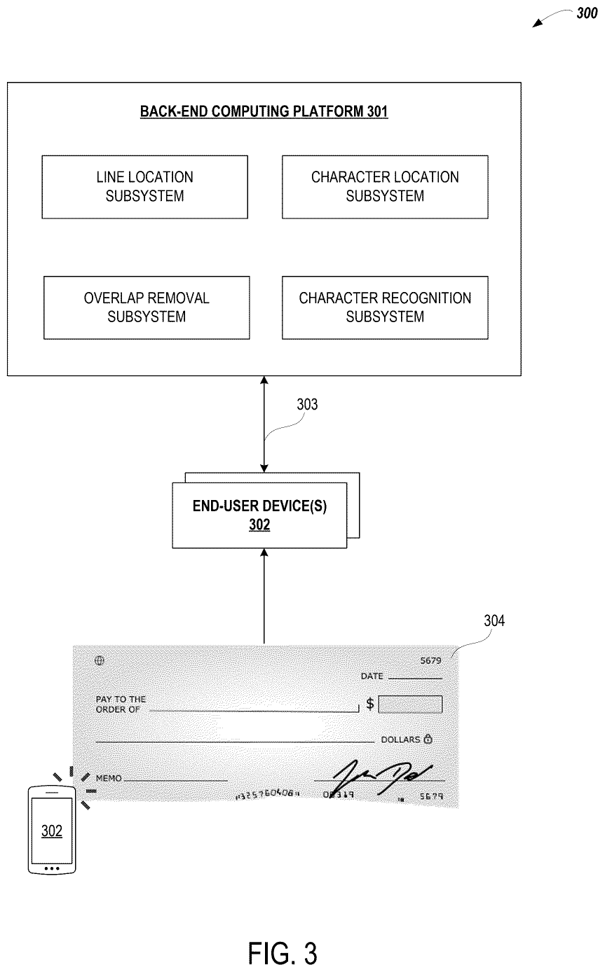

FIG. 3 depicts an example computing environment 300 in which example embodiments of the disclosed software technology may be implemented. The computing environment 300 may include an example back-end computing platform 301 that is configured to carry out some or all of the functions discussed herein, including any of the back-end platform functionality disclosed herein. In one implementation, as shown in FIG. 3, the back-end computing platform 301 may comprise one or more software subsystems, such as a line location subsystem, a character location subsystem, an overlap removal subsystem, and a character recognition subsystem, that each function to perform certain functionality related to the software technology disclosed herein. The back-end computing platform 301 may communicate with one or more computing devices, such as one or more end-user devices 302, via respective communication paths 303. The one or more end-user devices 302 may be configured to carry out some or all of the functions discussed herein, including any of the end-user device functionality disclosed herein.

In the examples below, the disclosed functionality may be discussed in the context of an image of a bank check that has been captured for mobile deposit and may reference the computing environment 300. For instance, in the examples discussed below, a back-end computing platform, such as the back-end computing platform 301, may communicate with an end-user device, such as the end-user device 302, which may comprise a consumer's smartphone, to receive image data corresponding to a scanned image of a physical artifact, such as a scanned image 304 of a physical bank check, which may be captured by a camera of the consumer's smartphone during the process of conducting a mobile deposit of the bank check via a banking software application that facilitates mobile deposits of bank checks. The image data corresponding to the scanned image 304 may take the form of black-and-white pixel data that indicates any characters (e.g., MICR line characters) and markings (e.g., handwritten markings) that are included in the image.

In some implementations, one or more skew and/or slant correction techniques may be applied to the image before the image is processed in accordance with the techniques disclosed herein.

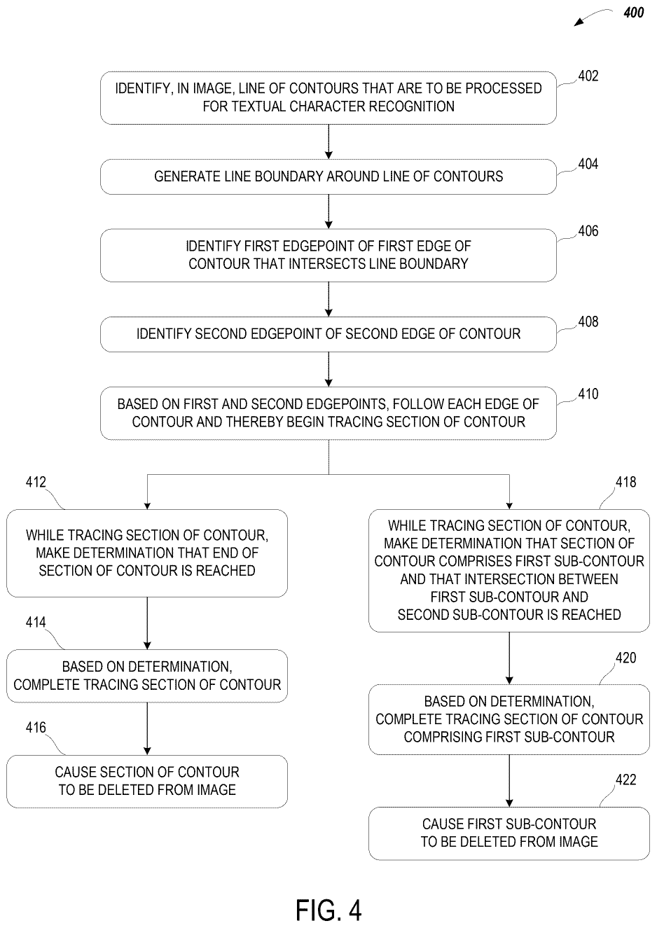

FIG. 4 provides a flow diagram of example functionality 400 for identifying and eliminating overlaps between characters in an image of a physical artifact according to one embodiment of the disclosed software technology. In practice, the example functionality 400 may be carried out by a back-end computing platform that may generally comprise some set of physical computing resources (e.g., processors, data storage, communication interfaces, etc.) that are utilized to implement the new software technology discussed herein. This set of physical computing resources may take any of various forms. As one possibility, the back-end computing platform may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the back-end computing platform may comprise “on-premises” computing resources of the organization that operates the back-end computing platform (e.g., organization-owned servers). As yet another possibility, the back-end computing platform may comprise a combination of cloud computing resources and on-premises computing resources. Further, as yet another possibility, the back-end computing platform may comprise one or more dedicated servers that have been provisioned with software for carrying out one or more of the back-end computing platform functions disclosed herein. The one or more computing resources of the back-end computing platform may take various other forms and be arranged in various other manners as well.

The back-end computing platform may be configured to communicate with one or more end-user devices over respective communication paths. The one or more end-user devices may take any of various forms, examples of which may include a desktop computer, a laptop, a netbook, a tablet, a smartphone, and/or a personal digital assistant (PDA), among other possibilities. Further, the one or more end-user devices may be associated with various types of users, including consumers of banking institutions, among other examples in accordance with the discussion above.

Each communication path between the back-end computing platform and an end-user device may generally comprise one or more communication networks and/or communications links, which may take any of various forms. For instance, each respective communication path may comprise any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path may be wireless, wired, or some combination thereof, and may carry data according to any of various different communication protocols. Although not shown, the respective communication paths may also include one or more intermediate systems. For example, it is possible that the back-end computing platform may communicate with a given end-user device via one or more intermediary systems, such as a host server (not shown). Many other configurations are also possible.

The back-end computing platform may also be configured to receive data from one or more external data sources that may be used to facilitate the functionality disclosed herein. For example, the back-end computing platform may be configured to receive image data from a third-party data source. Other examples are also possible. Further, the back-end computing platform may also be configured to communicate with one or more other computing platforms, such as a back-end computing platform associated with a banking institution in order to facilitate online banking tasks (e.g., mobile deposits, electronic funds transfers, etc.). Other examples are also possible.

In one implementation, the example functionality 400 may be carried out in a computing environment such as the computing environment 300 discussed above with reference to FIG. 3. In such an implementation, the example functionality 400 may be carried out by the back-end computing platform 301, which may communicate with one or more end-user devices 302 via respective communication paths 303, such as to receive image data corresponding to a scanned image 304 of a physical artifact, in accordance with the discussion above.

In practice, the example functionality 400 may be initiated after the back-end computing platform 301 obtains image data corresponding to an image of a physical artifact (e.g., the image 304 of the bank check). For instance, in accordance with the discussion above, a consumer of a financial institution may use the end-user device 302 (e.g., a smartphone) to access a banking software application that is hosted by the back-end computing platform 301 and may capture the image 304 using a camera of the end-user device 302, which may be provided to the back-end computing platform 301 via the software application in the form of black-and-white pixelized image data.

The example functionality may begin at 402, where the back-end computing platform 301 may identify, in the image, a line of contours that are to be processed for textual character recognition. Identifying the line of contours may take various forms. In one implementation, identifying the line of contours may involve performing a line location analysis to locate lines in the image. Performing a line location analysis may generally involve (i) identifying all contours in the image, (ii) sorting the contours by size into at least medium-sized and large-sized contours, where the large-sized contours include contours that exceed a largest expected character size within the image (e.g., contours that include overlaps in printed text with other markings, such as an overlap between a handwritten signature and a portion of a MICR line of a bank check), (iii) processing the medium-sized contours to allocate each medium contour to a given line, and (iv) processing the large-sized contours to allocate each large contour to an existing line. As noted above, a contour comprises a continuous set of pixels. Thus, each continuous set of pixels may indicate a respective contour.

In one implementation, the process of locating each line of contours in the image may begin by scanning the image data to identify each medium contour in the image and allocating it to a given line. In this respect, the scan may begin from one edge of the image and progress to the other edge of the image, scanning for contours in a single pass. For instance, in an implementation where the scan begins from a left edge of the image, the scan may proceed in a right-ward direction toward a right edge of the image. When a first contour is located, a first bounding box may be drawn around the contour, marking the start of a first line, and the scan may progress in a right-ward direction. When a second contour is located, a determination is made as to whether the second contour is part of the first line—i.e., whether or not the second contour has a similar y-axis value as the first contour—or part of a different line. This determination may take various forms.

As one possibility, the determination as to whether the second contour is part of the first line or part of a different line may involve (i) drawing a projected rectangle around the second contour, (ii) extending the projected box vertically—both upward and downward—by a threshold amount that attempts to avoid the location of other contours in other lines that may be in proximity of the second contour, and (iii) extending the projected rectangle laterally in a left-ward direction to locate any end-most contour in a line that has already been located along a similar y-axis value. In one embodiment, the threshold amount by which the projected box is extended vertically upward and downward may correspond to an amount that is less than a minimum vertical distance between any two given lines that may be included in a scanned image and greater than a maximum vertical distance between any two contours of a given character. In this respect, these maximum and minimum distances may be predetermined or otherwise derived based on image data obtained for the image of the bank check. Other examples are also possible.

While extending the projected rectangle, if a previously-located contour having a similar y-axis value is encountered (e.g., if the projected rectangle intersects the previously-located contour), the back-end computing platform 301 may determine that the second contour is part of the same line as the previously-located contour. Accordingly, the back-end computing platform 301 may add the second contour to the line including the previously-located contour and extend the bounding box defining the line to include the second contour. The scan may then continue to progress in the right-ward direction to locate additional contours and lines.

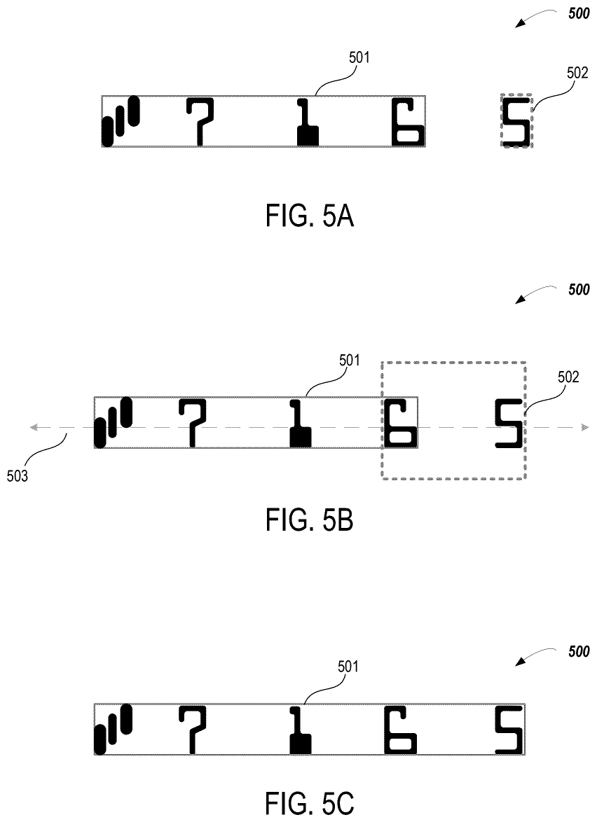

To illustrate with an example, consider FIG. 5A, which includes a line 500 encompassed by a bounding box 501 depicted in a solid outline, comprising four different contours that may have been identified and added to the line 500 during a scan of a bank check image in accordance with the discussion above. As the scan proceeds in a right-ward direction, a new contour may be located, and a projected rectangle 502, depicted in FIG. 5A by a dashed outline, may be drawn around the new contour. The projected rectangle 502 may be expanded vertically by a threshold amount and then extended in a left-ward direction to locate any other contours with a similar y-axis value, as shown in FIG. 5B. In the example of FIG. 5B, as the projected rectangle 502 is extended laterally in a left-ward direction, the end-most contour of the line 500, which has a similar y-axis value 503 as the new contour, may be located. Thus, the new contour may be added to the line 500, as shown in FIG. 5C.

In some instances, it is possible that a projected rectangle for a new contour may identify no other previously-located contours (e.g., where the new contour is the first-identified contour along a particular y-axis value). In such instances, the new contour may be determined to be a first contour of a new line, and a new bounding box representing the new line may be drawn around the new contour. The scan may then continue in a right-ward direction as described above to identify additional contours, each of which may either be added to an existing line or start a new line. As contours are located and added to lines in the image of the bank check and the scan progresses in a right-ward direction, eventually the right edge of the image will be reached.

Processing all of the medium-sized contours and allocating each medium contour to a respective line as described above may output an array of lines for the image, where each line comprises a set of medium contours that have a similar y-axis value. However, in some instances, one or more lines may have gaps corresponding to large contours that were previously identified and reserved for later processing (e.g., after medium contour processing is complete). To fill in these gaps, the large contours may be processed in order to allocate each large contour to an existing line and thereby add missing contours from the one or more lines.

Processing large contours may take various forms. In one implementation, the functionality of processing large contours may begin by the back-end computing platform 301 identifying large contours that intersect lines that were located in accordance with the discussion above. For each large contour that intersects a given line, the large contour may be added to the given line. After large contour processing has been completed and any contour gaps within the located lines of the scanned image have been filled in, the resulting output may comprise the array of lines with any previous gaps have been filled in, where each line comprises a respective set of contours (e.g., medium and possibly also large contours).

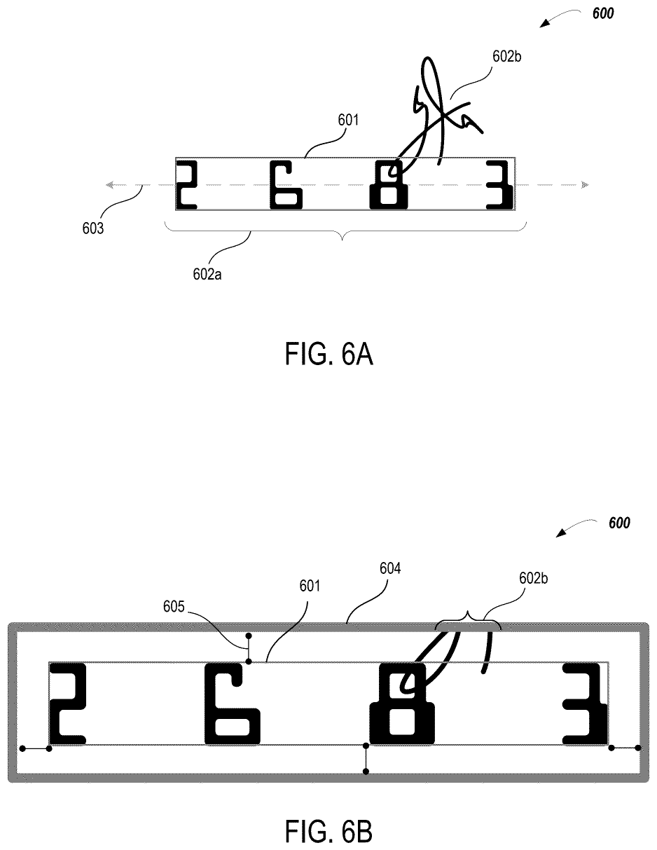

FIG. 6A depicts an example of a line 600, enclosed by a bounding box 601, that may have been located (e.g., in an image such as the image 304) using the line location techniques discussed above. In accordance with the discussion above, the line 600 may comprise a set of contours, including contours 602a having a similar y-axis value 603 (e.g., medium contours that were processed and added to the line 600) and contours 602b including overlaps between printed text and other markings (e.g., large contours that were processed and added to the line 600). However, it should be understood that other lines may include different sets of contours. For instance, in practice, the back-end computing platform 301 may begin applying the example functionality 400 to each line in the image 304, and not every line may include contours with overlaps, in which case the process of applying the example functionality 400 may end.

More information about line location techniques can be found in U.S. application Ser. No. 18/907,216, filed Oct. 4, 2024, and titled “Line Location and Character Identification Techniques for Optimal Character Recognition,” the contents of which are incorporated by reference herein in their entirety.

Returning to FIG. 4, at 404, the back-end computing platform 301 may generate a line boundary around the line of contours identified at 402. Generating the line boundary may take various forms. In one implementation, the back-end computing platform 301 may generate the line boundary based on applying a padding to the line of contours. The padding may take various forms. For instance, as one possibility, the padding may comprise a padding distance that is applied to a bounding box surrounding all medium contours within the line of contours. In this respect, the value for the padding distance may take various forms. For instance, as one possibility, the value for the padding distance may comprise a predetermined value indicating a number of points (e.g., pixels). For example, in one embodiment, the padding distance may be set to a value of five, and the back-end computing platform 301 may generate the line boundary based on applying a distance of five points to all sides of a bounding box that surrounds the medium contours. In other embodiments, the padding may take other forms and may be applied to the line of contours in other ways as well.

FIG. 6B depicts an example of generating a line boundary around the line of contours 600 shown in FIG. 6A. As shown in FIG. 6B, a line boundary 604 has been generated around the line 600. In accordance with the discussion above, the back-end computing platform 301 may generate the line boundary 604 based on applying a padding distance 605 (e.g., a value indicating a given number of rows and/or columns of points) above, below, and to either side of the bounding box 601 that surrounds the medium contours in the line 600.

Advantageously, generating a line boundary around a line of contours based on applying a padding distance to a bounding box enclosing medium contours of the line as described above provides a cushion around contours representing characters that are to be processed for character recognition (e.g., contours representing MICR line characters), thus decreasing the likelihood of mistakenly identifying portions of such contours for deletion from the image. Further, by generating the line boundary in this way, it can be inferred that any contours which intersect the line boundary (i.e., contours present in the padded region, such as one or more sections of the contours 602b shown in FIG. 6B) likely represent extraneous markings in the image that should not be processed for character recognition, such as portions of a handwritten signature that overlap a MICR line, and can thus be safely deleted from the image without compromising the integrity of contours that represent characters in the line.

Thus, after generating the line boundary as described above, the back-end computing platform 301 may determine if any contours intersect the line boundary, which may generally involve scanning points (i.e., pixels) along the line boundary to identify any contours that may intersect the line boundary. For instance, the back-end computing platform 301 may begin at a point at a first end of the line boundary and progressively scan each successive point along the line boundary until reaching a second end of the line boundary in order to determine if any points indicate a contour that intersects the line boundary. In this respect, the back-end computing platform 301 may determine that a point indicates an intersecting contour if a respective color of the point is different from a respective color of a background of the image. For example, if the background color of the image is indicated in the image data corresponding to the image by white points, the back-end computing platform 301 may determine that a non-white point (e.g., a black point, a gray point, etc.) found along the line boundary indicates an intersecting contour. Furthermore, the back-end computing platform 301 may determine that each continuous sequence of non-white points indicates a respective section of an intersecting contour. In this respect, each such sequence of non-white points may include a first edgepoint indicating a first edge of a section of an intersecting contour and a second edgepoint indicating a second edge of the section of the intersecting contour.

Thus, at 406 of the example functionality 400, the back-end computing platform 301 may identify a first edgepoint of a first edge of a contour that intersects the line boundary. In turn, at 408, the back-end computing platform 301 may identify a second edgepoint of a second edge of the contour that intersects the line boundary.

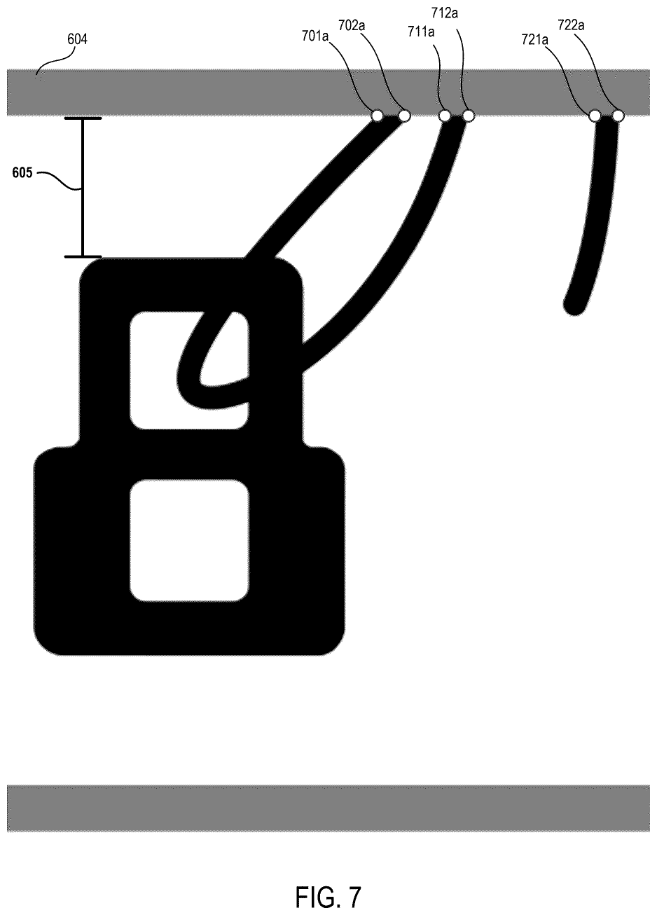

For instance, in the example of FIG. 6B, after generating the line boundary 604 around the contours of line 600, the back-end computing platform 301 may begin scanning the line boundary to identify any intersecting contours. For instance, the back-end computing platform 301 may begin at a left-most point along the top border of the line boundary 604 and progress in a right-ward direction, scanning points along the line boundary 604 to determine if any of the scanned points indicate intersecting contours. Turning now to FIG. 7, a close-up view of a portion of the line 600 is provided. As shown in FIG. 7, the back-end computing platform 301 may identify various sequences of black points intersecting the line boundary 604, including a first sequence of black points comprising a first edgepoint 701a and a second edgepoint 702a, a second sequence of black points comprising a first edgepoint 711a and a second edgepoint 712a, and a third sequence of black points comprising a first edgepoint 721a and a second edgepoint 722a.

In accordance with the discussion above, each pair of first and second edgepoints in a given sequence of black points may indicate respective edges of a respective section of a respective intersecting contour. For each sequence of black points, starting from the first and second edgepoints, the back-end computing platform 301 may follow each edge of the respective section of the respective intersecting contour and thereby begin tracing the respective section of the respective intersecting contour.

Thus, at 410 of the example functionality 400, based on the first and second edgepoints that were identified at 406 and 408, the back-end computing platform 301 may begin tracing a section of the contour that intersects the line boundary by following each edge of the contour.

The process for tracing a section of a contour may take various forms. For instance, in one implementation, tracing a section of the contour may generally involve starting from a first edgepoint along the first edge of the contour and the second edgepoint along the second edge of the contour, following the edges of the contour, and iteratively adding new edgepoints along the edges of the contour. In this respect, each new edgepoint that is added along a given edge may be added adjacently to a last edgepoint along the given edge, in a direction of the given edge. Further, new edgepoints may continue to be added to the edges of the contour until a stopping point is reached, which may take various forms as will be described in more detail further below.

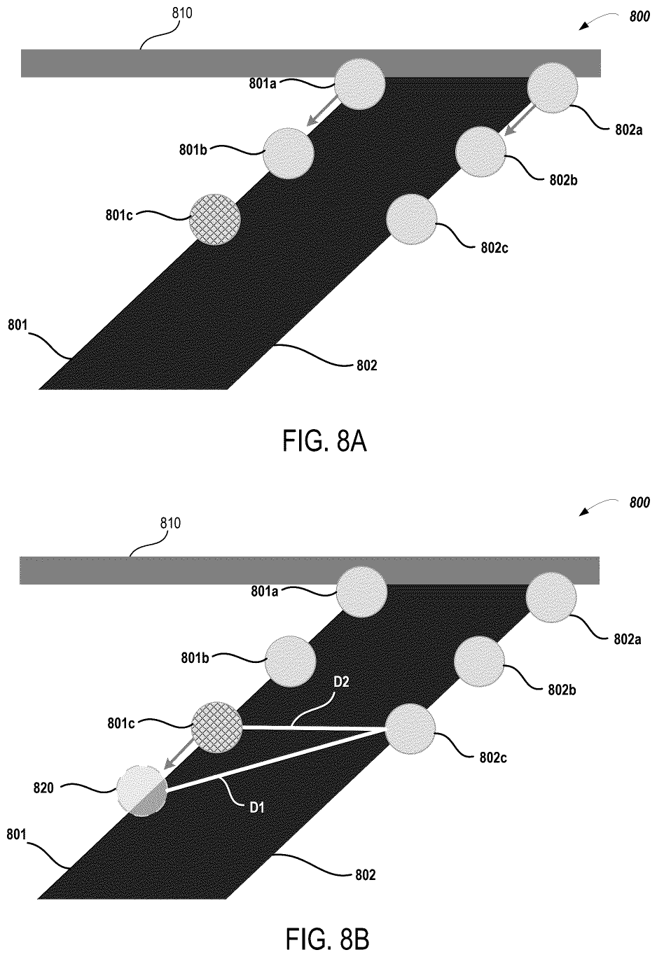

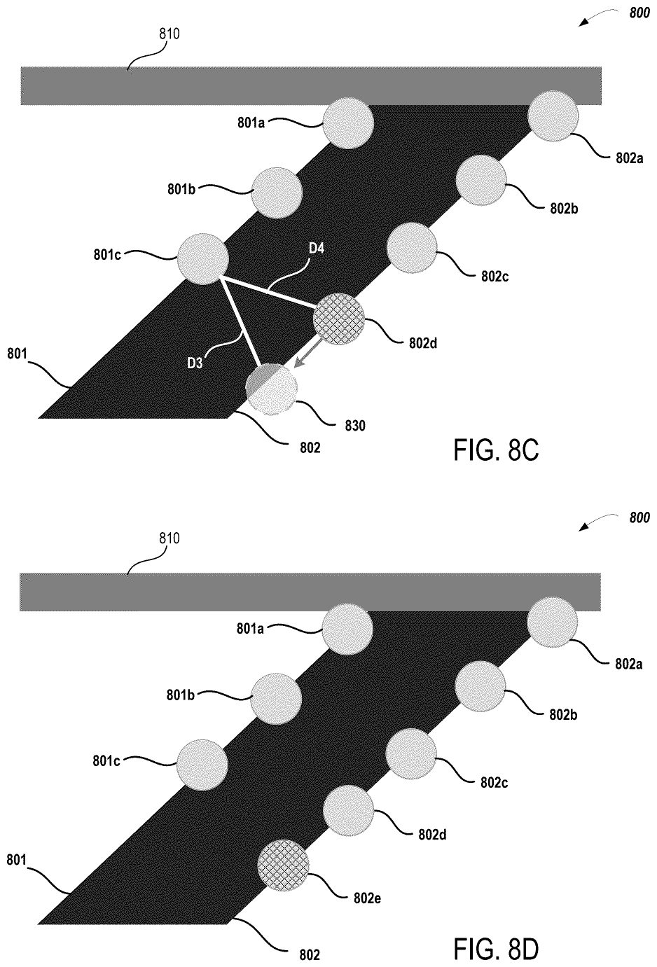

The process of tracing a section of a contour in accordance with one embodiment of the disclosed software technology will be described in more detail below with reference to FIGS. 8A-11, which provide examples of tracing contours by iteratively adding edgepoints. In these figures, the edgepoints are depicted as circles and are shown spaced apart for ease of illustration and explanation. However, it should be understood that the circles depicted in the figures represent adjacent pixels.

Turning first to FIG. 8A, a portion of a line 800 surrounded by a line boundary 810 is depicted. The line 800 may have been scanned by the back-end computing platform 301 to identify any contours that intersect the line boundary 810 as discussed above, based on which the back-end computing platform 301 may have identified a sequence of black points indicating a contour that intersects the line boundary 810 (which may be referred to herein as an “intersecting contour”), the sequence including a first edgepoint 801a on a first edge 801 of a section of the intersecting contour and a second edgepoint 802a on a second edge 802 of the section of the intersecting contour. The back-end computing platform 301 may then begin tracing the section of the intersecting contour by following the edges 801 and 802 and iteratively adding new adjacent edgepoints along the edges 801 and 802.

In the example of FIG. 8A, several adjacent edgepoints have been added to the edges 801 and 802 following the first edgepoint 801a and the second edgepoint 802a, indicating that several iterations of adding next adjacent edgepoints have been completed. For instance, an edgepoint 801b has been added adjacent to the first edgepoint 801a along the edge 801, an edgepoint 801c has been added adjacent to the edgepoint 801b along the edge 801, an edgepoint 802b has been added adjacent to the second edgepoint 802a along the edge 802, and an edgepoint 802c has been added adjacent to the edgepoint 802b along the edge 802. In this respect, the function of iteratively adding a next adjacent edgepoint to an edge of an intersecting contour may take various forms.

In one implementation, for each iteration of adding a next adjacent edgepoint, the back-end computing platform 301 may perform an evaluation to determine along which edge the next adjacent edgepoint should be added. The evaluation may involve calculating (i) a first distance between a next potential edgepoint on a given edge of the contour and a nearest edgepoint on the other edge of the contour and (ii) a second distance between a current edgepoint on the given edge of the contour and a nearest edgepoint on the other edge of the contour, and then comparing the first and second distance to determine which edge should include the new edgepoint. For instance, in one embodiment, if the first distance is greater than the second distance, then the next potential edgepoint may be added to the other edge instead of the given edge, and if the first distance is less than the second distance, then the next potential edgepoint may be added to the given edge instead of the other edge. Advantageously, by adding edgepoints iteratively in this way, new edgepoints may be added to each edge of the contour in a relatively even and consistent manner.

To illustrate with an example, with reference to FIG. 8A, let edgepoint 801c be a current edgepoint (indicated by patterned shading) along the edge 801 that was added during a most-recent iteration of adding edgepoints to the edges of the intersecting contour. Thus, for a next iteration, the back-end computing platform 301 may perform an evaluation to determine along which edge the next adjacent edgepoint should be added. For instance, as shown in FIG. 8B, the back-end computing platform 301 may calculate (i) a first distance D1 between a next potential edgepoint 820 along the given edge 801 and a nearest edgepoint along the other edge 802, which may be the edgepoint 802c, and (ii) a second distance D2 between the current edgepoint 801c on the given edge 801 and the nearest edgepoint along the other edge 802, which may be the edgepoint 802c. The back-end computing platform 301 may then compare the distances D1 and D2 in order to determine whether the next potential edgepoint 820 should be added to the edge 801 or the edge 802. For instance, as described above, (i) if D1 is greater than D2, then it may be determined that a next adjacent edgepoint should be added to the edge 801, and (ii) if D1 is less than D1, then it may be determined that the next adjacent edgepoint should be added to the edge 802. In the example of FIG. 8B, the back-end computing platform 301 may determine that D1 is greater than D2 and that the next adjacent edgepoint should thus be added to the edge 802.

Thus, as shown in FIG. 8C, based on comparing the distances D1 and D2, a next adjacent edgepoint has been added along the edge 802 as edgepoint 802d, which may also now represent the current edgepoint along edge 802, as indicated by the patterned shading. The back-end computing platform 301 may then perform a next iteration of adding edgepoints in accordance with the discussion above. For instance, the back-end computing platform 301 may compare (i) a first distance D3 between a next potential edgepoint 830 along the given edge 802 and a nearest edgepoint along the other edge 802, which may be the edgepoint 801c, and (ii) a second distance D4 between the current edgepoint 801d on the given edge 802 and the nearest edgepoint along the other edge 802, which may be the edgepoint 801c, based on which the back-end computing platform 301 may determine that D3 is less than D4, and a next adjacent edgepoint should thus be added to the edge 802. Thus, as shown in FIG. 8D, the next adjacent edgepoint has been added along the edge 802 as edgepoint 802e, which may also now represent the current edgepoint along edge 802.

The evaluation to determine along which edge a next adjacent edgepoint should be added may take other forms as well.

In accordance with the discussion above, the back-end computing platform 301 may continue to trace the section of the intersecting contour by iteratively adding new next adjacent edgepoints along the edges of the section of the intersecting contour, until a stopping point is reached. The stopping point may take various forms and may generally indicate an end to the tracing of the section of the contour. For instance, as one possibility, the stopping point may represent an end of the section of the contour that is being traced. As another possibility, the stopping point may represent an intersection between the section of the contour that is being traced and a new section of the contour. Other examples are also possible.

Returning to FIG. 4, at 412, while tracing the section of the intersecting contour, the back-end computing platform 301 may make a determination that an end of the section of the intersecting contour that is being traced has been reached. Thus, at 414, the back-end computing platform 301 may determine that tracing the section of the intersecting contour is complete. At 416, based on determining that tracing of the section of the intersecting contour is complete, the back-end computing platform 301 may cause the section of the intersecting contour that has been traced to be deleted from the image.

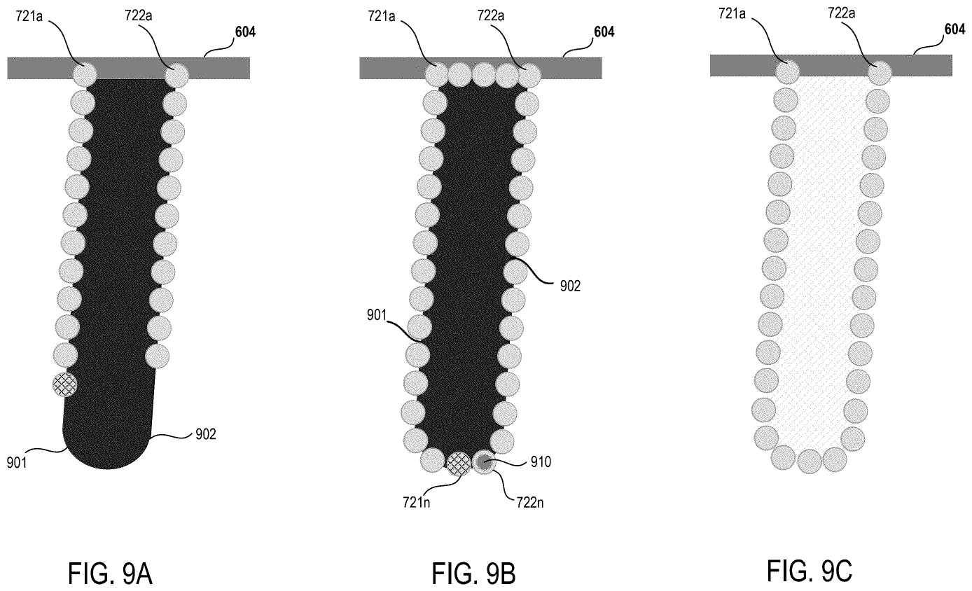

The determination that the end of the section of the contour being traced has been reached may take various forms. In one implementation, the determination that the end has been reached may comprise a determination that adding a next potential edgepoint would overlap with an existing edgepoint. To illustrate with an example, consider FIGS. 9A, 9B, and 9C, which provide close-up views of a portion of the line 600 comprising the edgepoints 721a and 722a of a contour which intersects the line boundary 604, as shown in FIG. 7. As shown in FIG. 9A, the first edgepoint 721a is located along a first edge 901 of the contour and the second edgepoint 722a is located along a second edge 902 of the contour. In accordance with the discussion above, the back-end computing platform 301 may begin tracing a section of the contour by following the edges 901 and 902 and iteratively adding adjacent edgepoints along the edges 901 and 902.

For instance, as shown in FIG. 9B, during the process of iteratively adding adjacent edgepoints, several additional adjacent edgepoints have now been added to the edges 901 and 902, including an edgepoint 721n comprising a current edgepoint of the edge 901, as indicated by the patterned shading. In accordance with the discussion above, the back-end computing platform 301 may perform an evaluation to determine along which one of the edges 901 or 902 a next potential edgepoint 910 is to be added. Based on the evaluation, the back-end computing platform 301 may determine that the next potential edgepoint 910 is to be added as a new adjacent edgepoint along the edge 901. However, as shown in FIG. 9B, the back-end computing platform 301 may also determine that adding the next potential edgepoint 910 as the new adjacent edgepoint along the edge 901 would overlap an existing edgepoint 722n along the edge 902, which may indicate that all possible edgepoints along the edges 901 and 902 have been added and that the section of the intersecting contour has thus been fully traced. Thus, the back-end computing platform 301 may determine that an end of the section of the intersecting contour has been reached and that tracing of the section is complete, based on which the back-end computing platform 301 may discontinue adding new edgepoints and cause the traced section of the intersecting contour to be deleted from the image.

Causing a section of a contour to be deleted from an image may take various forms. For instance, as one possibility, causing the section of the contour to be deleted may comprise updating a respective color of each point in the section to be changed from a first value to a second value that matches a background color of the image. For example, as mentioned above, and as shown in FIGS. 9A and 9B, the traced section of the intersecting contour may comprise a set of black points. Thus, causing the traced section to be deleted may involve updating the color of each point in the traced section from black to white such that the traced section of the intersecting contour becomes part of the image background and will thus be excluded from being processed for character recognition. For instance, as shown in FIG. 9C, the back-end computing platform 301 may cause the traced section of the intersecting contour to be deleted by causing a respective color of each black point in the traced section to be changed from black to white.

As another possibility, the stopping point may comprise an intersection between the section that is currently being traced and a new section of the intersecting contour. In such a situation, the section currently being traced may be referred to herein as a first sub-contour of the intersecting contour, and the new section may be referred to as a second sub-contour of the intersecting contour.

Returning briefly to FIG. 4, at 418, while tracing the section of the contour that intersects the line boundary, the back-end computing platform 301 may make a determination that the section of the intersecting contour that is currently being traced comprises a first sub-contour, and that an intersection between the first sub-contour and a second sub-contour has been reached. Thus, at 420, the back-end computing platform 301 may determine that tracing the section of the intersecting contour comprising the first sub-contour is complete. At 422, based on determining that tracing of the first sub-contour is complete, the back-end computing platform 301 may cause the first sub-contour to be deleted from the image.

The determination that a section of an intersecting contour that is currently being traced comprises a first sub-contour and that an intersection between the first sub-contour and a second sub-contour has been reached may take various forms.

In one implementation, while tracing the section of the intersecting contour as described above, the back-end computing platform 301 may calculate, for each new edgepoint that is added to a given edge of the section of the intersection contour, (i) a respective edgepoint angle and (ii) a respective edgepoint width and then compare those values with a respective edgepoint angle and a respective edgepoint width of a corresponding edgepoint on the other edge of the section of the intersection contour in order to determine whether an intersection between the section of the contour being traced (e.g., a first sub-contour of the contour) and another section of the contour (e.g., a second sub-contour of the contour) is reached. For instance, the back-end computing platform 301 may determine that an intersection between a first sub-contour and a second sub-contour is reached if either (i) a difference between a respective edgepoint angle of a current edgepoint on a first edge of an intersecting contour and a respective edgepoint angle of a current edgepoint on a second edge of the intersecting contour is greater than a maximum angle threshold, or (ii) a respective edgepoint width of the current edgepoint on either the first edge or the second edge is greater than a maximum width threshold.

An edgepoint angle of any given edgepoint may comprise a value between 0 and 359 degrees (e.g., starting at 0 degrees to the right and moving counterclockwise), and may be determined by calculating a line of best fit between the given edgepoint and one or more preceding edgepoints along the given edge. In practice, the respective edgepoint angles of the current edgepoints along each edge of a given sub-contour of a contour will typically have correlating values because the edges of the given sub-contour are typically parallel to each other and follow a similar direction. Accordingly, a divergence in the respective edgepoint angles of the current edgepoints may indicate an intersection with another sub-contour of the contour. Thus, the maximum angle threshold may comprise a value that captures such an edgepoint angle divergence that is indicative of a sub-contour intersection. In this respect, a threshold value that is set too high may cause a beginning of an intersection between two sub-contours to be overlooked, which may result in some points of a contour representing a character being deleted from the image, which is undesirable. Similarly, a threshold value that is set too low may cause a false determination of an intersection. Thus, the threshold value may comprise a value that provides a sufficient margin for acceptable divergences between respective edgepoint angles while also capturing divergences that may indicate intersections. For instance, as one example, the threshold value may comprise a difference of 15 degrees, although other examples are also possible.

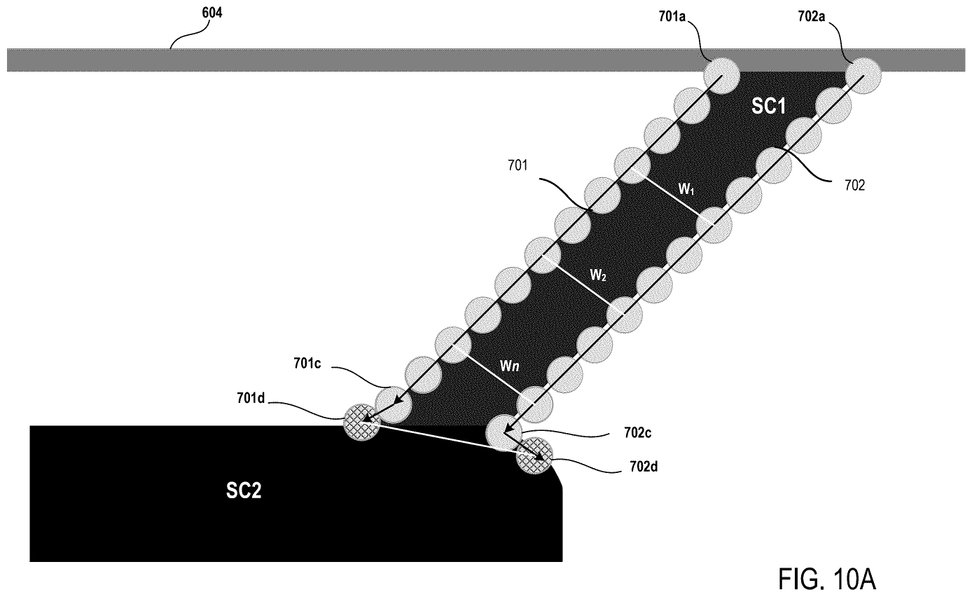

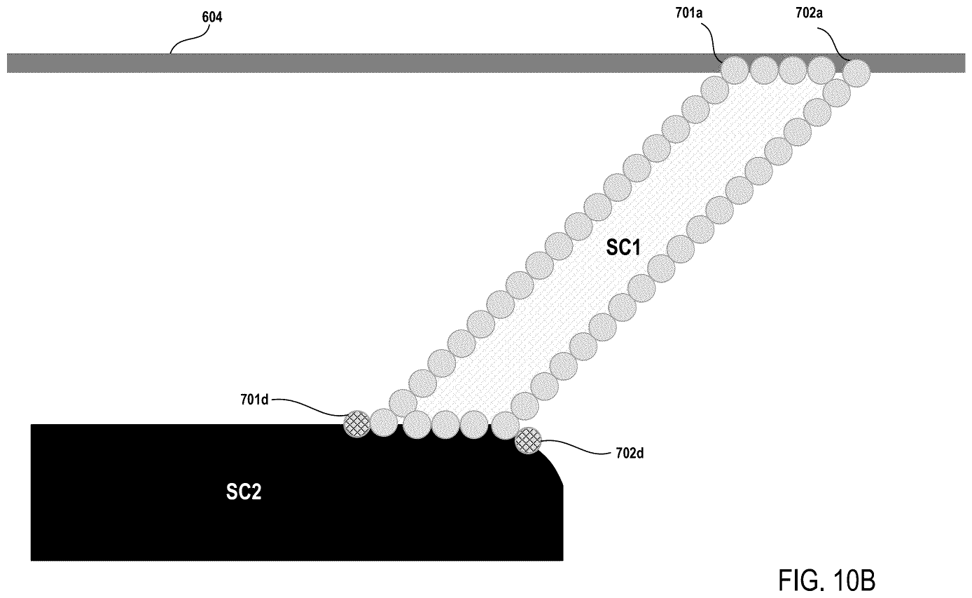

To illustrate with an example, consider FIG. 10A, which depicts a close-up view of a portion of the line 600 comprising the first and second edgepoints 701a and 702a of a section “SC1” of a contour that intersect the line boundary 604. In accordance with the discussion above, the back-end computing platform 301 may begin tracing the section SC1 by iteratively adding next adjacent edgepoints along the edges 701 and 702, starting from the first and second edgepoints 701a and 702a. During each iteration, the back-end computing platform 301 may calculate, for each new edgepoint that is added along a given edge 701 or 702, a respective edgepoint angle and compare the respective edgepoint angle of the new edgepoint to a respective edgepoint angle of a current edgepoint along the other edge in order to determine whether a difference between the respective edgepoint angles exceeds the maximum angle threshold, as discussed above. If the difference between the respective edgepoint angles does not exceed the maximum angle threshold, the back-end computing platform 301 may continue to trace the section of the contour by iteratively adding edgepoints as described above. However, if the difference between the respective edgepoint angles does exceed the maximum angle threshold, the back-end computing platform 301 may stop tracing the section of the contour and cause the section to be deleted.

As shown in FIG. 10A, while tracing the section SC1, the back-end computing platform 301 may calculate, for each of a current edgepoint 701d added along the edge 701 and a current edgepoint 702d added along the edge 702, a respective edgepoint angle. Based on comparing the respective edgepoint angles of the edgepoints 701d and 702d, the back-end computing platform 301 may determine that a difference between the respective edgepoint angles exceeds a maximum threshold angle. Thus, the back-end computing platform 301 may determine that the section SC1 comprises a first sub-contour of the intersecting contour, and an intersection between the first sub-contour and a second sub-contour of the intersecting contour (depicted in FIG. 10A as “SC2”) is reached. In turn, as shown in FIG. 10B the back-end computing platform 301 may complete tracing the section SC1 (e.g., by adding interior points to connect edgepoints 701d and 702d) and cause the section SC1 to be deleted from the image, which may involve updating a respective color of each point in the section SC1 from black to white, as discussed above.

An edgepoint width of any given edgepoint on a given edge of the intersecting contour may comprise a distance between the given edgepoint and a nearest edgepoint on the other edge of the intersecting contour. In effect, the edgepoint width may indicate a width (e.g., at the given edgepoint) of the section of the contour that is being traced. Accordingly, a divergence in the edgepoint width may indicate an intersection between a first sub-contour and a second sub-contour of the intersecting contour. Thus, the maximum width threshold may comprise a value that captures such an edgepoint width divergence that is indicative of a sub-contour intersection. The maximum width threshold may take various forms. In one embodiment, the maximum width threshold may be derived based on calculating an average edgepoint width of each edgepoint on the given edge and then multiplying the average edgepoint width by a predetermined parameter to allow for some variation in contour width. Other examples are also possible.

For instance, in the example of FIG. 10A, while tracing the section SC1, the back-end computing platform 301 may compare an edgepoint width representing the respective edgepoint widths of the edgepoints 701n and 702n to an average edgepoint width (e.g., the sum of edgepoint widths W₁, W₂, . . . Wₙ divided by n) based on which the back-end computing platform 301 may determine that the edgepoint width exceeds the average width. Thus, as discussed above, the back-end computing platform 301 may determine that the section SC1 comprises a first sub-contour of the intersecting contour, and an intersection between the first sub-contour and the second sub-contour SC2 of the intersecting contour is reached. In turn, as shown in FIG. 10B the back-end computing platform 301 may complete tracing the section SC1 and cause the section SC1 to be deleted from the image, which may involve updating a respective color of each point in the section SC1 from black to white, as discussed above.

The stopping point based on which the back-end computing platform 301 may determine that tracing the section of the intersecting contour is complete may take other forms as well.

In practice, a marking on a physical artifact may overlap a given character in the physical artifact in more than one area. For instance, a portion of a signature may overlap a given character in multiple parts, as can be seen in the examples shown in FIGS. 6A and 6B, where multiple sections of the contours 602b intersect a given character in the line 600. Thus, it is possible that in a situation where the back-end computing platform 301 identifies an intersection between a first sub-contour and a second sub-contour, a third sub-contour comprising a continuation of the first sub-contour may extend beyond the intersection - that is, the third sub-contour may intersect the second sub-contour on the other side of the intersection between the second sub-contour and the first sub-contour.

For this reason, in instances where the back-end computing platform 301 identifies an intersection between a first sub-contour and a second sub-contour as discussed above, the back-end computing platform 301 may determine whether a third sub-contour that is a continuation of the first sub-contour extends beyond the intersection, which may involve traversing the intersection to look for a third sub-contour on the other side.

Traversing an intersection may take various forms. In one implementation, the process of traversing the intersection may generally involve (i) determining a direction of travel for traversing the intersection, (ii) iteratively traversing the intersection in the direction of travel, and (iii) for each iteration of traversing the intersection, determining whether any points outside the intersection are found within a given distance perpendicular to the direction of travel.

Determining a direction of travel for traversing the intersection may take various forms. In general, the direction of travel for traversing the intersection may reflect the direction of the first sub-contour, such that the intersection may be traversed in a direction following the direction of the first sub-contour, thereby increasing the likelihood of discovery of any third sub-contour comprising a continuation of the first sub-contour that extends beyond the intersection, based on an inference that a third sub-contour comprising a continuation of the first sub-contour would have a direction similar to the direction of the first sub-contour. In one embodiment, determining the direction of travel may involve (i) identifying the last edgepoint on a given edge which has (1) an edgepoint angle that differs from a corresponding last edgepoint on the other edge by less than the maximum angle threshold and (2) a respective edgepoint width that is less than the maximum width threshold, (ii) calculating an average of the respective edgepoint angles of the last edgepoints, and (iii) determining the direction of travel based on the average of the respective edgepoint angles of the last edgepoints.

In practice, a given current edgepoint based on which the back-end computing platform 301 determines that an intersection between the first and second sub-contours has been reached may be located at an intersection between the first and second sub-contours or along an edge of the second sub-contour and may therefore have a respective edgepoint angle and/or respective edgepoint width that diverges from the respective edgepoint angles and/or respective edgepoint widths of previous edgepoints on the same edge. Thus, determining the direction of travel based on the current edgepoint used to identify the intersection may yield a direction that does not accurately reflect the direction of the first sub-contour. Therefore, “stepping back” by one or more edgepoints to identify a pair of edgepoints that satisfied the angle and width thresholds to determine the direction of travel as described above advantageously enables a more accurate determination of the direction of the first sub-contour, in a manner that may avoid the intersection with the second sub-contour.

The direction of travel may be determined in other ways as well.

Iteratively traversing the intersection in the direction of travel may take various forms. As one possibility, iteratively traversing the intersection in the direction of travel may begin with (i) identifying a middle point between the respective last edgepoints and (ii) determining an iteration distance that is to be traversed during each iteration. In this respect, the iteration distance may be derived based on determining a first distance between the current edgepoint (e.g., the given edgepoint based on which the back-end computing platform 301 determines that the intersection between the first and second sub-contours has been reached) along a given edge and the respective last edgepoint used to determine the direction of travel. Accordingly, the first distance may represent how far the computing platform stepped back to find a pair of edgepoints that satisfied the angle and width thresholds. In some implementations, a predetermined value (e.g., one point, two points, etc.) may be added to this first distance to determine the iteration distance. Advantageously, determining the iteration distance in this way yields a distance that increases the likelihood of traversing through the intersection at a consistent pace and decreases the likelihood of traversing too far during each iteration such that a third sub-contour may be missed. Other examples of determining the iteration distance are also possible.

After identifying the middle point and determining the iteration distance, the back-end computing platform 301 may iteratively traverse the intersection. For instance, beginning from the middle point, the back-end computing platform 301 may, for each iteration, travel through the intersection by the iteration distance in the direction of travel in order to determine whether a third sub-contour continuing from the first sub-contour extends beyond the intersection.

For each iteration that the intersection is traversed by the iteration distance, the back-end computing platform 301 may make a determination of whether a third sub-contour that comprises a continuation of the first sub-contour is found. This determination may take various forms. In one implementation, as mentioned above, the back-end computing platform 301 may determine whether any points outside the intersection (e.g., any white points) are found within a given distance perpendicular to the direction of travel.

The given distance within which white points outside the intersection are sought (which may be referred to here as the “perpendicular distance”) may be determined according to a width of the first sub-contour, based on an inference that a third sub-contour comprising a continuation of the first sub-contour is likely to have a width similar to the width of the first sub-contour. For instance, as one example, the given distance may comprise a maximum width of the first sub-contour in order to account for any fluctuations in the width of the first sub-contour. In this respect, the maximum width of the first sub-contour may be determined based on the respective edgepoint widths of one or more edgepoints of the first-contour, as previously described above. For example, the maximum width may be determined based on comparing the respective edgepoint width of each edgepoint along the edges of the first sub-contour within the padded region (e.g., between the line boundary and the intersection between the first and second sub-contours) to identify a highest value and then using that value as the maximum width. Other examples are also possible. The perpendicular distance may take other forms as well.

For each iteration of traversing the intersection for the iteration distance along the direction of travel, the back-end computing platform 301 may determine, in each of a first direction and a second direction perpendicular to the direction of travel, if a white point can be found within the given distance. For instance, starting from the middle point, the back-end computing platform 301 may perform a first iteration by traversing the intersection for the iteration distance along the direction of travel and arriving at a first iteration point. From the first iteration point, the back-end computing platform 301 may then determine whether any white points are found within the perpendicular distance in either direction perpendicular to the direction of travel. If no white point is found within the perpendicular distance in either direction perpendicular to the direction of travel, the back-end computing platform 301 may determine that the process of traversing the intersection is not complete, and may proceed to perform a next iteration of traversing the intersection. For instance, starting from the first iteration point, the back-end computing platform 301 may perform a second iteration by traversing the intersection for the iteration distance along the direction of travel and arriving at a second iteration point. From the second iteration point, if no white point is found within the perpendicular distance in either direction perpendicular to the direction of travel, the back-end computing platform 301 may determine that the process of traversing the intersection is not complete, and may perform a next iteration of traversing the intersection.

The back-end computing platform 301 may continue to iteratively traverse the intersection in this way until either (i) finding a third sub-contour comprising a continuation of the first sub-contour or (ii) determining that a third sub-contour does not exist.

Finding a third sub-contour may take various forms. For instance, as one possibility, while traversing the intersection along the direction of travel in increments of the iteration distance, the back-end computing platform 301 may find a first white point within the perpendicular distance in a first direction perpendicular to the direction of travel, which may indicate that at least a portion of the intersection has been traversed, and a third sub-contour is reached. Thus, the back-end computing platform 301 may determine that the third sub-contour has been found and may proceed to identify a first and second starting edgepoint for the third sub-contour. For instance, as one possibility, the back-end computing platform 301 may identify a point of intersection between the second sub-contour and the third sub-contour along a given edge of the third sub-contour that is nearest to the first white point and identify the point of intersection as a first starting edgepoint of the given edge. Further, based on the respective starting edgepoint of the given edge, the back-end computing platform 301 may identify a corresponding second starting edgepoint of the other edge of the third sub-contour. For instance, in one implementation, the back-end computing platform 301 may continue to traverse the intersection along the direction of travel until finding a second white point within the perpendicular distance in a second direction perpendicular to the direction of travel, and then identifying a second point of intersection between the second sub-contour and the third sub-contour along the other edge of the third sub-contour that is nearest to the second white point as the second starting edgepoint for the third sub-contour. The first and second starting edgepoints for the third sub-contour may be identified in other ways as well. Based on identifying the first and second starting edgepoints, the back-end computing platform 301 may process the third sub-contour for deletion by tracing the third sub-contour as described above with reference to FIG. 4, until a stopping point, such as an end of the third sub-contour or an intersection between the third sub-contour and a fourth sub-contour, is reached.

Determining that a third sub-contour does not exist may take various forms. As one possibility, determining that a third sub-contour does not exist may comprise finding a white point along the direction of travel, which may indicate that the intersection has been fully traversed and a third sub-contour does not exist, in which case the back-end computing platform 301 may determine that processing the current intersecting contour is complete and may proceed to begin processing a different intersecting contour as described above. As another possibility, determining that a third sub-contour does not exist may comprise determining that a maximum traversal distance has been traversed and no white points, either along the direction of travel or within the perpendicular distance, have been found. In any event, if no third sub-contour is found, the back-end computing platform 301 may determine that processing the intersecting contour for deletion is complete, based on which the back-end computing platform 301 may proceed with processing one or more other contours of the line that also intersect the line boundary, or determine that the line is ready to be processed for character recognition.

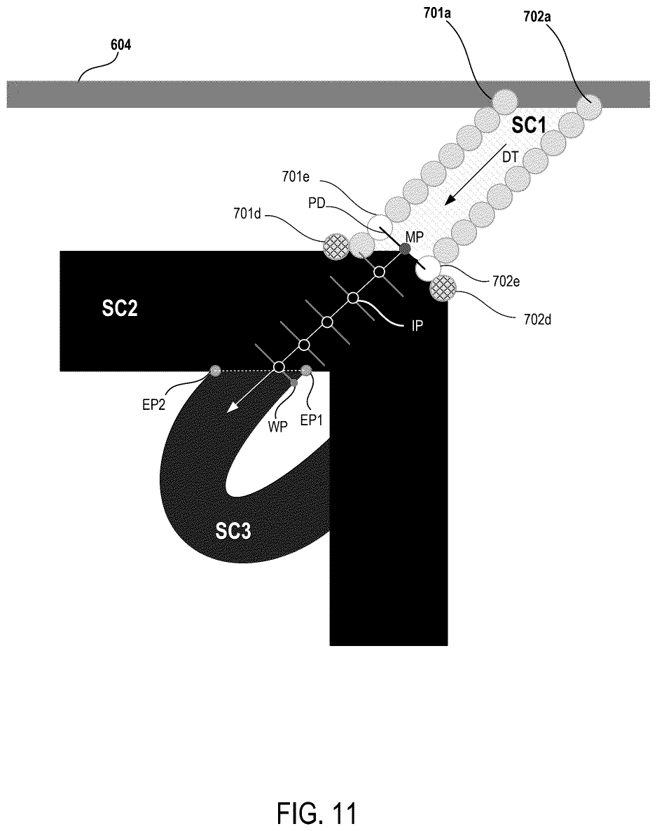

Turning now to FIG. 11, an illustration of traversing an intersection between a first and second sub-contour is provided. FIG. 11 depicts a zoomed-out view of the portion of the line 600 depicted in FIG. 10B after the sub-contour SC1 is deleted. In accordance with the discussion above, based on determining that the first sub-contour SC1 intersects the second sub-contour SC2, the back-end computing platform 301 may proceed to traverse the intersection and thereby determine if a third sub-contour comprising a continuation of the sub-contour SC1 can be found. For instance, the back-end computing platform 301 may determine a direction of travel “DT” for traversing the intersection, which may involve (i) stepping back along the edges of the first sub-contour SC1 to identify an edgepoint 701e and an edgepoint 702e that comprise respective last edgepoints on each edge of the sub-contour SC1, where a difference between the respective edgepoint angles of the edgepoints 701e and 702e is less than a maximum angle threshold, and where each respective edgepoint width of the edgepoints 701e and 702e is less than a maximum width threshold, (ii) calculating an average of the respective edgepoint angles of the edgepoints 701e and 702e, and (iii) identifying the direction of travel based on the average of the respective edgepoint angles of the edgepoints 701e and 702e.

After identifying the direction of travel DT, the back-end computing platform 301 may proceed to traverse the intersection as described above. For instance, the back-end computing platform 301 may identify a middle point “MP” between the edgepoints 701e and 702e, which may serve as a starting point for iteratively traversing the intersection. Further, the back-end computing platform 301 may determine an iteration distance based on which the intersection is to be iteratively traversed, which may represent how far (e.g., a number of points) the back-end computing platform 301 stepped back to find the edgepoints 701e and 702e when determining the direction of travel DT as described above.

In turn, as described above, the back-end computing platform 301 may begin to iteratively traverse the intersection, starting from the middle point MP, in the direction of travel DT, by the iteration distance. Each iteration that may be performed by the back-end computing platform 301 is depicted in FIG. 11 by a respective iteration point “IP.”

As described above, for each iteration of traversing the intersection, the back-end computing platform 301 may search for any white points (i.e., points outside of the intersection) within a given distance “PD” perpendicular to the direction of travel that is determined based on a maximum width of the sub-contour SC1. For instance, at each iteration point IP, the back-end computing platform 301 may “step out,” one point at a time, in each direction extending perpendicularly from the iteration point IP for a distance totaling the distance PD, and determine if any white point is found while stepping out. If no white point is found, the back-end computing platform 301 may continue traversing the intersection by performing a next iteration.

In the example of FIG. 11, the back-end computing platform 301 may perform five such iterations, as indicated by the five iteration points IP. During a fifth iteration, the back-end computing platform 301 may discover a white point WP, based on which the back-end computing platform 301 may determine that a third sub-contour SC3 extends from the other side of the sub-contour SC2. In turn, the back-end computing platform 301 may proceed to identify edgepoints EP1 and EP2, which may serve as starting edgepoints for tracing the sub-contour SC3 for deletion as discussed above.

The process for identifying contours that are to be deleted from an image may take other forms as well.

For instance, according to another implementation of the disclosed software technology, the process for identifying contours for deletion may begin in a manner similar to the functionality 400 described above with reference to FIG. 4. For instance, the back-end computing platform 301 may identify a line of contours that are to be processed for textual character recognition, generate a line boundary around the line of contours, and identify a first edgepoint of a first edge and a second edgepoint of a second edge of a contour that intersects the line boundary.

After identifying the first and second edgepoints, the back-end computing platform 301 may detect one or more edges inside the line boundary, which may take various forms. For instance, as one possibility, the back-end computing platform 301 may apply one or more image processing techniques for finding boundaries of objects within an image, based on which the back-end computing platform 301 may identifying edges of contours that are present within the line boundary. One example of such an image processing technique may involve utilizing an edge detection algorithm (e.g., Canny edge detection, Laplacian edge detection, Prewitt edge detection, Roberts Cross edge detection, Scharr edge detection, etc.) that is configured to identify edges of objects (e.g., contours) within an image and output a segmented image of lines and boundaries representing the identified objects. Other examples are also possible.

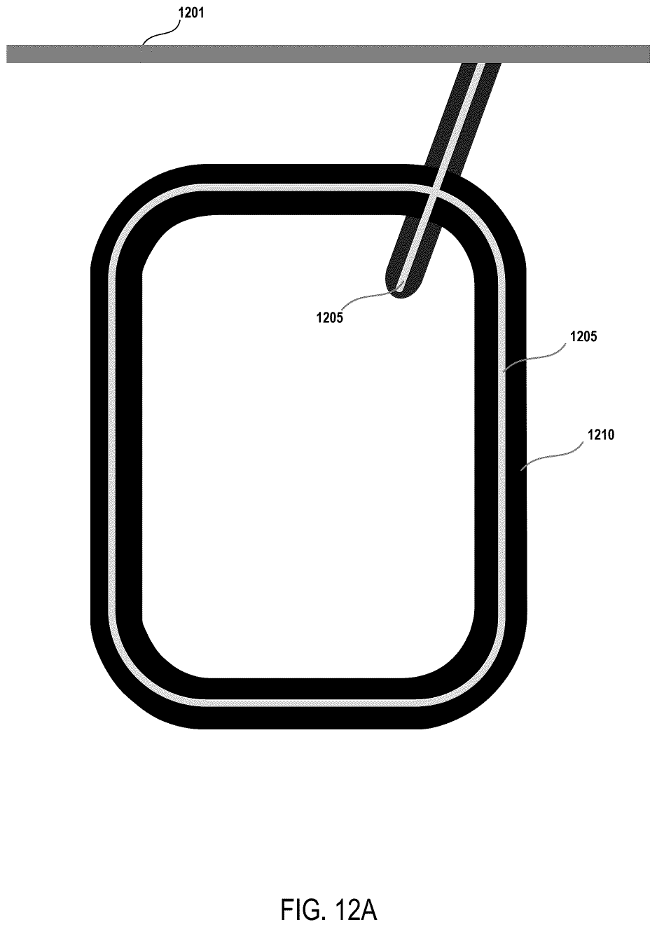

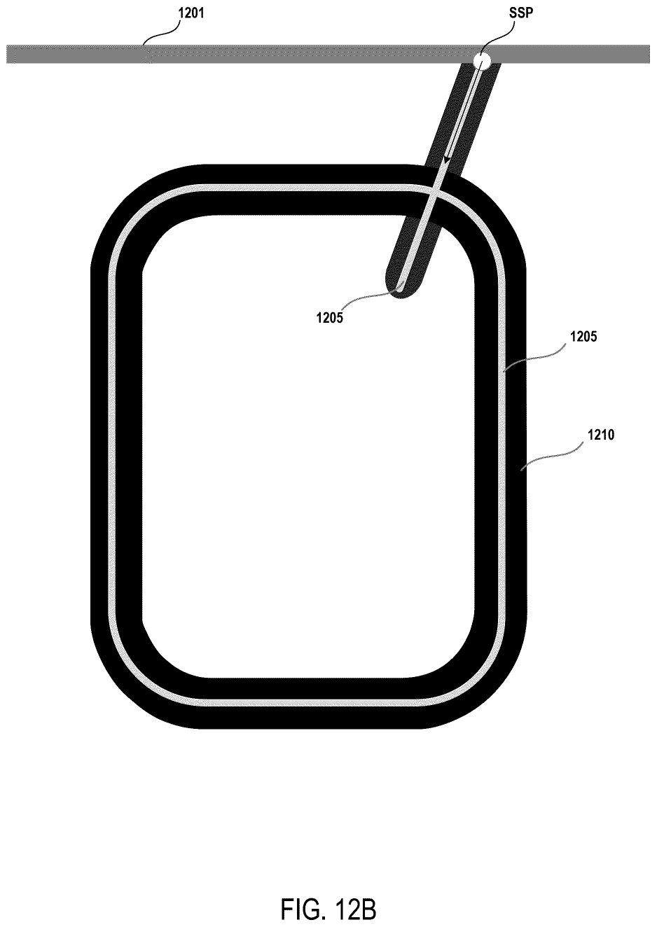

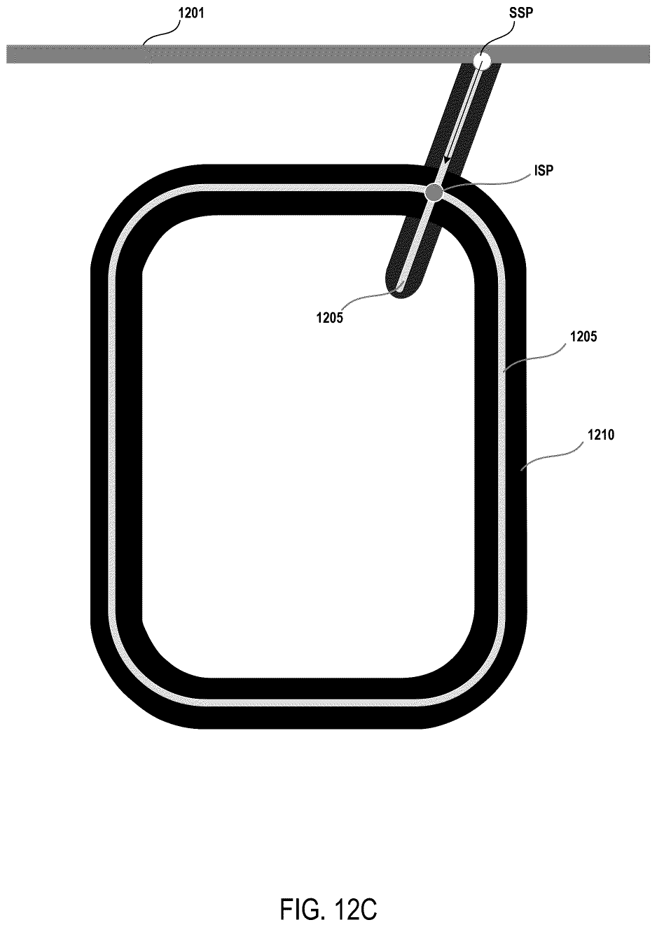

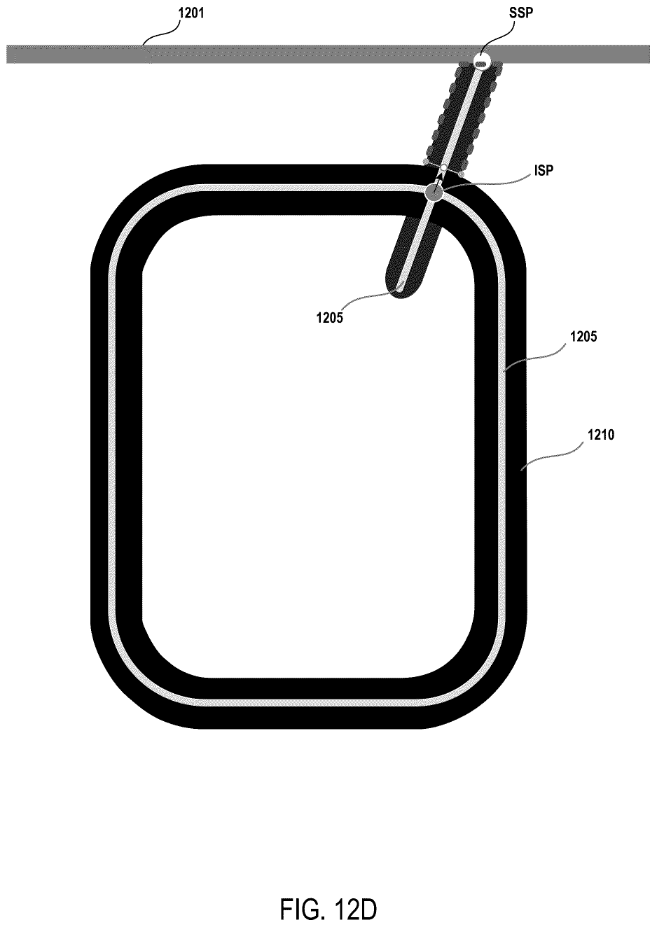

After detecting the edges of the contours that are present within the line boundary, the back-end computing platform 301 may proceed to trace the contours, which may take various forms. For instance, as one possibility, the back-end computing platform 301 may apply one or more skeletonization techniques that are configured to analyze an image and reduce foreground regions in the image, thereby outputting a one-pixel-wide “skeleton” (also referred to herein as a “skeletal line”) that reflects geometrical properties (e.g., such as medial axes) of objects within the image. The skeletonization techniques may take various forms, such as a Ling Dong skeletonization algorithm, among other possibilities. Based on applying the skeletonization technique, the back-end computing platform 301 may obtain a skeleton of each contour within the line boundary. FIG. 12A depicts one such example of a skeletal line 1205 of a contour 1210 that intersects a line boundary 1201.

Based on obtaining the skeletons of the contours within the line boundary, the back-end computing platform 301 may follow each contour, which may generally involve, for a given contour, (i) identifying a starting skeletal point (SSP) and (ii) iteratively traversing the skeletal line in a direction away from the line boundary until an intersection skeletal point (ISP) is found. A starting skeletal point may comprise a skeletal point along a skeletal line of the given contour that intersects the line boundary. An intersection skeletal point may comprise a skeletal point along the skeletal line that is located within an intersection between a first sub-contour and a second sub-contour and may be indicated by three or more neighboring skeletal points. For instance, as shown in FIG. 12B, the back-end computing platform 301 may identify an SSP along the skeletal line 1205 that intersects the line boundary 1201 and may then begin traversing the skeletal line 1205 in a direction away from the line boundary 1201 to determine if an ISP is found.

While traversing the skeletal line 1205, the back-end computing platform 301 may identify an ISP, as shown in FIG. 12C, which may indicate an intersection between the first sub-contour and the second sub-contour of the given contour. Thus, the back-end computing platform 301 may determine that an intersection between the first sub-contour and the second sub-contour is reached. In turn, the back-end computing platform 301 may proceed to trace a border around the first sub-contour and then cause the first sub-contour to be deleted from the image. In one implementation, as shown in FIG. 12D, tracing a border around the first sub-contour may generally involve “stepping back” from the ISP to a point along the skeletal line 1205 where a width of the first sub-contour is less than a maximum contour width (which may be determined in various ways depending on the implementation, including as one example, a predetermined value), moving outwardly in a lateral direction away from each side of the point toward a respective edge of the first sub-contour, and thereby identifying a pair of corresponding lateral edgepoints along the edges of the first sub-contour.

As shown in FIG. 12D, based on the lateral edgepoints, the back-end computing platform 301 may trace a border around the first sub-contour that extends from the lateral edgepoints in a direction toward the line boundary 1201. When the line boundary 1201 is reached, the back-end computing platform 301 may complete defining the border for the first sub-contour and thereafter cause the first sub-contour to be deleted from the image, which may involve updating a respective color of each point in the first sub-contour from black to white as described above.

Based on identifying the intersection between the first sub-contour and the second sub-contour, the back-end computing platform 301 may determine if a third sub-contour comprising a continuation of the first sub-contour that extends beyond the intersection is found, which may generally involve “stepping forward” from the ISP to a point along the skeletal line 1205, past the intersection, where a width of the first sub-contour is less than the maximum contour width. If the point is not found, the back-end computing platform 301 may determine that no third sub-contour exists, and that processing the given contour for deletion is complete. If the point is found, the back-end computing platform 301 may determine that the third sub-contour is reached, in which case the back-end computing platform 301 may identify the point as a new SSP based on which the skeletal line is to be traversed for identifying a new ISP, defining a border for the third sub-contour, and causing the third sub-contour to be deleted as described above.

After an image has been processed to identify and delete contours representing markings other than characters that are to be processed for character recognition as described above, the back-end computing platform 301 may proceed to identify the remaining contours in the image, more information about which may be found in U.S. application Ser. No. 18/907,216, previously incorporated above.

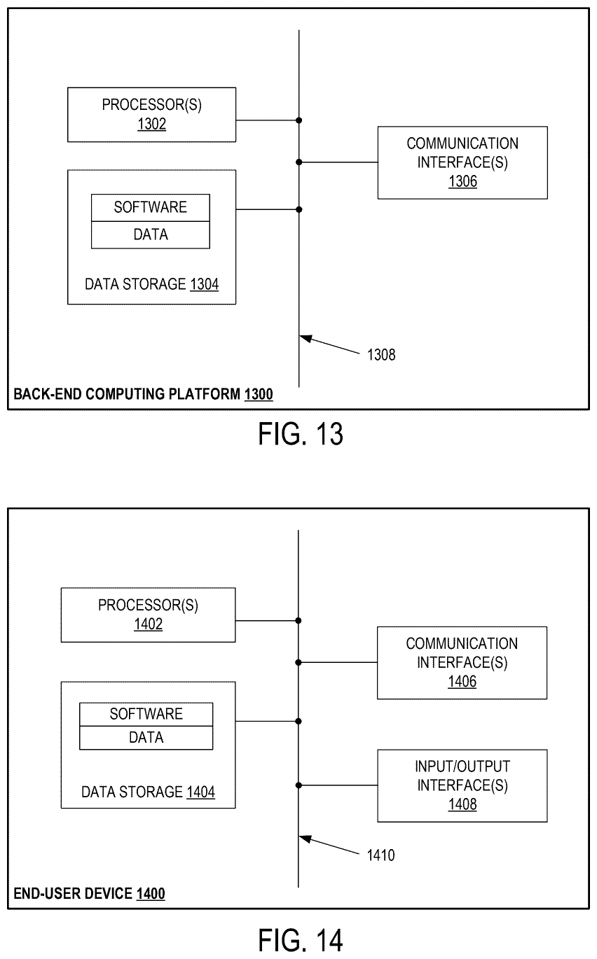

Turning now to FIG. 13, a simplified block diagram is provided to illustrate some structural components that may be included in an example back-end computing platform 1300 that may be configured to carry out any of the various back-end platform functions disclosed herein. At a high level, the example back-end computing platform 1300 may generally comprise any one or more computing systems that collectively include one or more processors 1302, data storage 1304, and one or more communication interfaces 1306, all of which may be communicatively linked by a communication link 1308 that may take the form of a system bus, a communication network such as a public, private, or hybrid cloud, or some other connection mechanism. Each of these components may take various forms.

The one or more processors 1302 may each comprise one or more processing components, such as general-purpose processors (e.g., a single-or a multi-core central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed. It should also be understood that the one or more processors 1302 could comprise processing components that are distributed across a plurality of physical computing systems connected via a network.

In turn, the data storage 1304 may comprise one or more non-transitory computer-readable storage mediums that are collectively configured to store (i) program instructions that are executable by the one or more processors 1302 such that the back-end computing platform 1300 is configured to perform any of the various functions disclosed herein, including but not limited to any of the back-end platform functions disclosed herein, and (ii) data that may be received, derived, or otherwise stored, for example, in one or more databases, file systems, repositories, or the like, by the back-end computing platform 1300, in connection with performing any of the various back-end platform functions disclosed herein. In this respect, the one or more non-transitory computer-readable storage mediums of the data storage 1304 may take various forms, examples of which may include volatile storage mediums such as random-access memory, registers, cache, etc., and non-volatile storage mediums such as read-only memory, a hard-disk drive, a solid-state drive, flash memory, an optical-storage device, etc. It should also be understood that the data storage 1304 may comprise computer-readable storage mediums that are distributed across a plurality of physical computing systems connected via a network.

The one or more communication interfaces 1306 may be configured to facilitate wireless and/or wired communication with other systems and/or devices. Additionally, in an implementation where the back-end computing platform 1300 comprises a plurality of physical computing systems connected via a network, the one or more communication interfaces 1306 may be configured to facilitate wireless and/or wired communication between these physical computing systems (e.g., between computing and storage clusters in a cloud network). As such, the one or more communication interfaces 1306 may each take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

Although not shown, the back-end computing platform 1300 may additionally include or have one or more interfaces for connecting to one or more user-interface components that facilitate user interaction with the back-end computing platform 1300, such as a keyboard, a mouse, a trackpad, a display screen, a touch-sensitive interface, a stylus, a virtual-reality headset, and/or one or more speaker components, among other possibilities.

It should be understood that the back-end computing platform 1300 is one example of a computing platform that may be used with the embodiments described herein. Numerous other arrangements are possible and contemplated herein. For instance, in other embodiments, the back-end computing platform 1300 may include additional components not pictured and/or more or fewer of the pictured components.

Turning to FIG. 14, a simplified block diagram is provided to illustrate some structural components that may be included in an example end-user device 1400 that may be configured to carry out any of the various functions disclosed herein, including but not limited to any of the various end-user device functionality discussed above. As shown in FIG. 14, the end-user device 1400 may include one or more processors 1402, data storage 1404, one or more communication interfaces 1406, and one or more input/output (I/O) interfaces 1408, all of which may be communicatively linked by a communication link 1410 that may take the form of a system bus or some other connection mechanism. Each of these components may take various forms.

The one or more processors 1402 may comprise one or more processing components, such as general-purpose processors (e.g., a single-or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 1404 may comprise one or more non-transitory computer-readable storage mediums that are collectively configured to store (i) program instructions that are executable by the processor(s) 1402 such that the end-user device 1400 is configured to perform any of the end-user device functions disclosed herein, and (ii) data that may be received, derived, or otherwise stored, for example, in one or more databases, file systems, repositories, or the like, by the end-user device 1400. In this respect, the one or more non-transitory computer-readable storage mediums of the data storage 1404 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. The data storage 1404 may take other forms and/or store data in other manners as well.

The one or more communication interfaces 1406 may be configured to facilitate wireless and/or wired communication with other computing devices. The communication interface(s) 1406 may take any of various forms suitable to provide for any of various types of wireless communication (e.g., Wi-Fi communication, cellular communication, short-range wireless protocols, etc.) and/or wired communication. Other configurations are possible as well.

The end-user device 1400 may additionally include or have interfaces for one or more I/O interfaces 1408 that can be used to facilitate user interaction with the end-user device 1400, such as a keyboard, a mouse, a trackpad, a display screen, a touch-sensitive interface, a stylus, a virtual-reality headset, one or more microphone components, and/or one or more speaker components, among other possibilities.

It should be understood that the end-user device 1400 is one example of an end-user device that may be used to interact with an example computing platform as described herein. Numerous other arrangements are possible and contemplated herein. For instance, in other embodiments, the end-user device 1400 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. Claims should not be construed as requiring action by such actors unless explicitly recited in claim language.

1. A computing platform comprising:
at least one processor;
at least one non-transitory computer-readable medium; and
program instructions stored on the at least one non-transitory computer-readable medium that, when executed by the at least one processor, cause the computing platform to:
identify, in an image, a line of contours that are to be processed for textual character recognition;
generate a line boundary around the line of contours;
identify a first edgepoint of a first edge of a contour that intersects the line boundary;
identify a second edgepoint of a second edge of the contour;
based on the first and second edgepoints, follow each edge of the contour and thereby begin tracing a section of the contour;
while tracing the section of the contour, make a determination that the section of the contour comprises a first sub-contour of the contour and that an intersection between the first sub-contour and a second sub-contour of the contour is reached;
based on the determination, complete tracing the section of the contour comprising the first sub-contour; and
cause the first sub-contour to be deleted from the image.

2. The computing platform of claim 1, wherein the program instructions that, when executed by the at least one processor, cause the computing platform to generate the line boundary around the line of contours comprise program instructions that, when executed by the at least one processor, cause the computing platform to:
sort contours in the image by size into at least medium contours and large contours, wherein the line of contours comprises a plurality of medium contours and at least one large contour; and
generate the line boundary by adding a padding distance around a bounding box that surrounds the medium contours in the line of contours.

3. The computing platform of claim 2, wherein the padding distance is five pixels.

4. The computing platform of claim 1, wherein the program instructions that, when executed by the at least one processor, cause the computing platform to follow each edge of the contour and thereby begin tracing the section of the contour comprise program instructions that, when executed by the at least one processor, cause the computing platform to:
for the first edge of the contour, iteratively add a next adjacent edgepoint to the first edge, starting from the first edgepoint; and
for the second edge of the contour, iteratively add a next adjacent edgepoint to the second edge, starting from the second edgepoint.

5. The computing platform of claim 4, further comprising program instructions that, when executed by the at least one processor, cause the computing platform to:
compare (i) a first distance between a next potential edgepoint on a given edge of the contour and a nearest edgepoint on the other edge of the contour and (ii) a second distance between a current edgepoint on the given edge of the contour and a nearest edgepoint on the other edge of the contour; and
based on comparing the first and second distances:
if the first distance is greater than the second distance, add a next edgepoint on the other edge; or
if the first distance is less than the second distance, add a next edgepoint on the given edge.

6. The computing platform of claim 4, further comprising program instructions stored on the at least one non-transitory computer-readable medium that, when executed by the at least one processor, cause the computing platform to:
for each edgepoint that is iteratively added to an edge, determine (i) a respective edgepoint angle and (ii) a respective edgepoint width,
wherein the determination that the intersection between the first sub-contour and the second sub-contour is reached comprises a determination that either (i) a difference between the respective edgepoint angle of a current edgepoint on the first edge and the respective edgepoint angle of a current edgepoint on the second edge is greater than a maximum angle threshold or (ii) a respective edgepoint width of the current edgepoint on either the first edge or the second edge is greater than a maximum width threshold.

7. The computing platform of claim 6, wherein an edgepoint angle comprises an angle of a line of best fit between a given edgepoint on a given edge and one or more preceding edgepoints on the given edge.

8. The computing platform of claim 6, wherein the maximum angle threshold is fifteen degrees.

9. The computing platform of claim 6, wherein an edgepoint width comprises a distance between a given edgepoint on a given edge of the contour and a nearest edgepoint on the other edge of the contour, and wherein the maximum width threshold is derived based on an average of respective edgepoint widths for all edgepoints on the section of the contour.

10. The computing platform of claim 4, further comprising program instructions stored on the at least one non-transitory computer-readable medium that, when executed by the at least one processor, cause the computing platform to:
after making the determination that the intersection between the first sub-contour and the second sub-contour is reached, determine whether a third sub-contour that is a continuation of the first sub-contour extends beyond the intersection by:
(i) determining a direction of travel for traversing the intersection;
(ii) iteratively traversing the intersection in the direction of travel; and
(iii) for each iteration of traversing the intersection, determining whether any points outside the contour are found within a given distance perpendicular to the direction of travel.

11. The computing platform of claim 10, wherein:
(i) determining the direction of travel for traversing the intersection comprises:
identifying a last edgepoint on a given edge that has a respective edgepoint angle that differs from a corresponding last edgepoint on the other edge by less than the maximum angle threshold and a respective edgepoint width less than the maximum width threshold;
calculating an average of the respective edgepoint angles of the last edgepoints; and
determining the direction of travel based on the average of the respective edgepoint angles;
(ii) iteratively traversing the intersection in the direction of travel comprises:
identifying a middle point between the last edgepoint on the given edge and the corresponding last edgepoint on the other edge; and
based on the middle point, perform one or more iterations of traversing the intersection in the direction of travel, wherein each iteration comprises an iteration distance that is derived based on a distance between the last edgepoint on the given edge and a current edgepoint on the given edge; and
(iii) determining whether any points outside the contour are found within a given distance perpendicular to the direction of travel comprises:
determining a maximum width of the first sub-contour, wherein the given distance comprises the maximum width; and
for each iteration, determining (a) if a point outside the contour is found in a first lateral direction perpendicular to the direction of travel and (b) if a point outside the contour is found in a second lateral direction perpendicular to the direction of travel.

12. The computing platform of claim 1, wherein the contour is a first contour, the computing platform further comprising program instructions that, when executed by the at least one processor, cause the computing platform to:
identify a first edgepoint of a first edge of a second contour that intersects the line boundary;
identify a second edgepoint of a second edge of the second contour;
based on the first and second edgepoints, follow each edge of the second contour and thereby begin tracing a section of the second contour;
while tracing the section of the second contour, make a determination that an end of the second contour is reached;
based on the determination, complete tracing the section of the second contour; and
cause the second contour to be deleted from the image.

13. The computing platform of claim 12, wherein:
the program instructions that, when executed by the at least one processor, cause the computing platform to follow each edge of the second contour and thereby begin tracing the section of the second contour comprise program instructions that, when executed by the at least one processor, cause the computing platform to:
for the first edge of the second contour, iteratively add a next adjacent edgepoint to the first edge, starting from the first edgepoint; and
for the second edge of the second contour, iteratively add a next adjacent edgepoint to the second edge, starting from the second edgepoint; and
the determination that the end of the second contour is reached comprises a determination that a next potential edgepoint on a given edge would overlap an existing edgepoint on the other edge.

14. The computing platform of claim 1, wherein the program instructions that, when executed by the at least one processor, cause the computing platform to cause the section of the contour to be deleted from the image comprise program instructions that, when executed by the at least one processor, cause the computing platform to:
update a respective color of each pixel in the section of the contour to match a background color of the image.

15. The computing platform of claim 1, wherein each contour comprises a respective set of contiguous pixels identified in image data corresponding to the image.

16. The computing platform of claim 1, wherein the line of contours comprises a set of contours having a substantially similar y-axis value or x-axis value within the image.

17. A non-transitory computer-readable medium, wherein the non-transitory computer-readable medium is provisioned with program instructions that, when executed by at least one processor, cause a computing platform to:
identify, in an image, a line of contours that are to be processed for textual character recognition;
generate a line boundary around the line of contours;
identify a first edgepoint of a first edge of a contour that intersects the line boundary;
identify a second edgepoint of a second edge of the contour;
based on the first and second edgepoints, follow each edge of the contour and thereby begin tracing a section of the contour;
while tracing the section of the contour, make a determination that the section of the contour comprises a first sub-contour of the contour and that an intersection between the first sub-contour and a second sub-contour of the contour is reached;
based on the determination, complete tracing the section of the contour comprising the first sub-contour; and
cause the first sub-contour to be deleted from the image.

18. The non-transitory computer-readable medium of claim 17, wherein the program instructions that, when executed by at least one processor, cause the computing platform to generate the line boundary around the line of contours comprise program instructions that, when executed by at least one processor, cause the computing platform to:
sort contours in the image by size into at least medium contours and large contours, wherein the line of contours comprises a plurality of medium contours and at least one large contour; and
generate the line boundary by adding a padding distance around a bounding box that surrounds the medium contours in the line of contours.

19. The non-transitory computer-readable medium of claim 17, wherein the program instructions that, when executed by at least one processor, cause the computing platform to follow each edge of the contour and thereby begin tracing the section of the contour comprise program instructions that, when executed by at least one processor, cause the computing platform to:
for the first edge of the contour, iteratively add a next adjacent edgepoint to the first edge, starting from the first edgepoint; and
for the second edge of the contour, iteratively add a next adjacent edgepoint to the second edge, starting from the second edgepoint.

20. A method carried out by a computing platform, the method comprising:
identifying, in an image, a line of contours that are to be processed for textual character recognition;
generating a line boundary around the line of contours;
identifying a first edgepoint of a first edge of a contour that intersects the line boundary;
identifying a second edgepoint of a second edge of the contour;
based on the first and second edgepoints, following each edge of the contour and thereby begin tracing a section of the contour;
while tracing the section of the contour, making a determination that the section of the contour comprises a first sub-contour of the contour and that an intersection between the first sub-contour and a second sub-contour of the contour is reached;
based on the determination, completing tracing the section of the contour comprising the first sub-contour; and
causing the first sub-contour to be deleted from the image.
